(19) United States
(12) Patent Application Publication
(10) Pub. No.: US 2004/0226593 A1
(43) Pub. Date: Nov. 18, 2004

(54) Walking cane

(76) Inventors: Mathieu Robitaille, Montreal (CA); Adrienne Haswell, Montreal (CA)

Correspondence Address: Louis Tessier, 60 Balfour, Town of Mount-Royal, QC, H3P 1L6, CA

(21) Appl. No.: 10/704,865

(22) Filed: Nov. 12, 2003

Related U.S. Application Data
(60) Provisional application No. 60/425,114, filed on Nov. 12, 2002.

(51) Int. Cl. A61H 3/02; A45B 9/04

(52) U.S. Cl. 135/77

(57) ABSTRACT

A walking cane for at least partially supporting the weight of an intended user as the latter is walking includes a handle section for allowing grasping of the cane, a sole section for engaging the ground surface and a stem section extending between the handle section and the sole section. The handle section projects substantially forwardly from the stem section and has a generally elongated configuration. The stem section has a generally elongated configuration and a substantially continuous stem outer wall. The stem section is configured and sized so as to substantially compensate without substantially bending for bending moments created in the stem section during use of the walking cane. Typically, the handle section, the stem section and the sole section are configured and sized so that the stem longitudinal axis is substantially in register with the cane center of gravity when the cane is in a substantially vertical orientation and so that the vertical component of the force exerted by the user on the cane is in a substantially collinear relationship with the stem longitudinal axis.

### CROSS-REFERENCE TO RELATED APPLICATIONS

This application claims the benefit of PPA Ser.No. 60/425,114, filed Nov. 12, 2002 by the present inventors.

### FIELD OF THE INVENTION

The present invention relates to the general field of ambulation assisting devices and is particularly concerned with a walking cane.

### BACKGROUND OF THE INVENTION

It is a well-known fact that our population is aging. With aging there is an increase in the incidence of disabilities that can cause pain, a loss of balance or general weakness in the lower extremities and subsequently requiring the use of an ambulatory aid. Walking canes are the most common and widely used ambulatory aids and should therefore be a product that provides the user with maximum support and stability.

Most conventional walking canes include an elongated shank provided with a ground engaging tip at a first longitudinal end thereof and a grasping handle adjacent a second longitudinal end thereof. Typically, a walking cane acts as a replacement for an incapacitated leg. The user of the cane conventionally holds onto the cane handle with an arm and, instead of placing pressure on the hindered leg, leans on the cane. The cane is hence used mainly for stability or balance purposes while the legs of the intended user achieve the forward movement.

Although popular and somewhat useful, conventional walking canes nevertheless have numerous drawbacks. One of these drawbacks relates to the fact that conventional cane handle sections often have poor ergonomics.

For example, a particularly popular type of prior art walking cane includes a generally hook-shaped or somewhat rectilinear handle section extending substantially perpendicularly from the shank of the cane. Due to the relative position of the hook or rectilinear handles relative to the shank portion of the cane it is often necessary to place the entire hand distally relative to the centerline of the shank. This creates an ergonomically maladaptive relationship between the user and the cane.

Indeed, instead of promoting proper axial alignment of the hand and wrist with the radius and ulna bones of the arm, the hook and rectilinear handle sections promotes maximum wrist extension. Placing the wrist in full extension and applying weight through the upper extremity can, in turn, cause improper positioning of cartilage between arm and wrist and also may potentially increase tensional stress on anatomic structures located in the wrist joint and the flexor tendons on the palmar side of the wrist.

Accordingly, by off-setting the position of the hand relative to the center line of the stem, conventional cane handle sections substantially diminish comfort and benefit due to muscular fatigue of hand, forearm and shoulder and, over the long term, may promote the degeneration of anatomical structures.

Furthermore, conventional cane handle sections typically concentrate pressure on areas of the hand least suited for bearing such loads. For example, the load is often concentrated on the adductor pollicis muscle located in the web of the hand between the thumb and forefinger and on the volar aspect of the palm. This type of load distribution may, in turn, result in the compression of anatomical structures again leading to decreased comfort in the short term and potential injury in the long term.

Still furthermore, conventional hook or rectilinear-type cane handles often allow the cane to move sideways either away or towards the intended user, making it necessary to apply intensive grip on the handle to control the cane. Over time, the user tends to loosen the grip on the handle and consequently reduce control of the cane without awareness of the situation. Since the user relies on the cane for stability, this may potentially lead to instability and injury related to a fall.

With conventional hook-type cane handles the stability problem is further compounded by the fact that the user's hand often tends to slip around the curve of the hook either towards the free hand thereof or towards the shank of the cane thereby reducing the ability of the intended user to control the cane from moving fore or aft.

Also, most conventional cane handle sections promote the creation of a bending moment potentially leading to deflection of the cane shank resulting in overall cane instability. Hence, cane shanks must be designed for increased structural resistance. The increased structural resistance of the shank, in turn, leads to increased weight and/or manufacturing costs.

The hereinabove mentioned drawbacks associated with conventional cane handles are often compounded by the fact that the walking canes are typically used by elderly people or disabled individuals whose hands are, at least to some extent, disabled due to age, disease or both by various types of ailments such as arthritis, arthrosis or the like.

The ground engaging tip portion of conventional canes has also been associated with various types of drawbacks. Typically, the walking canes are extended at an angle forwardly or rearwardly during use. The design of conventional walking cane tips often do not allow the latter to get adequate traction with ground surfaces, hence potentially causing the cane to slip away from the user. This may not only prove to be annoying but also potentially dangerous.

Part of the problem associated with conventional walking cane tips stems from the fact that the ground-engaging portion of the tip typically provides only a small ground-engaging surface. While the prior art has shown some attempts of providing a somewhat larger ground-engaging surface, such prior art cane tips have often proven to be cumbersome and require the user to lift at a substantially higher lever a somewhat heavier cane as steps are taken. Lifting of the cane at a higher lever is not only tiresome but also increases instability.

Furthermore, when an intended user extends the cane forwardly in order to take a step, the cane is typically slightly oblique relative to the ground. If the walking surface is somewhat slippery because, for example, of liquids lying thereon or because of a layer of ice, the tip of the cane may tend to slide forwardly, thereby causing the intended user to loose balance. Furthermore, in situations wherein the ground is relatively soft, such as when the cane is being used on sand, loose gravel, soft earth or the like, the conventional cane tips tend to sink into the supporting surface allowing the intended user to topple sidewise when body weight is transferred to the cane.

Still furthermore, most conventional cane tips are not well adapted to re-distribute the dynamic forces created between the cane and the ground surface. Also, most canes are only adapted to be used on a given type of ground surface and, hence, lack in versatility.

A further drawback associated with most conventional canes is that they are often not adapted to be self-standing when not in use, requiring individuals to abut the cane against a supporting structure or allow the cane to fall on the ground. Furthermore, should the cane slip out of the hand of an intended user, the cane will need to be picked up off the ground which may prove to be difficult for disabled individuals. Although some prior art walking canes have been provided with wider bases such as tripods, such prior art canes have proven not to be ergonomic and relatively cumbersome.

The shank portion of conventional walking canes has also been associated with various drawbacks. Indeed, most conventional walking canes are provided with shanks having a non-adjustable length. Accordingly, the cane is not well adapted to be customized for various settings such as when the cane is being used on an uneven terrain. Moreover, in situations wherein the cane may be used by various individuals of different heights, several canes must be purchased in order to meet the ergonomic needs of each individual. Still furthermore, in situations wherein the cane needs to be stowed away temporarily, such as during travel or during remission of ailments, the prior art canes having non-adjustable shank length require a considerable amount of storage space.

Also, the shank portion of conventional walking canes are often not well adapted to provide an increased moment of inertia in various directions for increasing structural parameters for a given type and size of material. Accordingly, in order to provide adequate structural rigidity, some prior art canes are either oversized or formed out of overly expensive material.

Still furthermore, most prior art walking canes define a relatively small sustentation polygon and a relatively high center of gravity, again leading to the cane being potentially tipped over. Also, the configuration of the prior art walking cane has often lead to interference with the movement of the leg and foot of the intended user in close proximity to the cane.

Accordingly, there exists a need for an improved walking cane. It is therefore a general object of the present invention to provide such an improved walking cane.

### SUMMARY OF THE INVENTION

In accordance with the present invention, there is provided a walking cane for at least partially supporting the weight of an intended user as the latter is walking, the walking cane comprising: a handle section for allowing grasping of the cane, a sole section for engaging the ground surface and a stem section extending between the handle section and the sole section; the handle section projecting substantially forwardly from the stem section, the handle section having a generally elongated configuration defining a handle longitudinal axis, a handle rear end located adjacent the stem section and a longitudinally opposed handle front end; the stem section having a generally elongated configuration defining a stem longitudinal axis, a stem proximal end located adjacent the handle section and a stem distal end located adjacent the sole section; the stem having a substantially continuous stem outer wall; the stem section being configured and sized so as to substantially compensate without substantially bending for bending moments created in the stem section during use of the walking cane.

Typically, the stem section includes a bending moment compensating segment located intermediate the stem proximal and distal ends for compensating the bending moments created in the stem section during use.

Conveniently, the stem section further includes a stem connecting segment located adjacent the stem proximal end for allowing attachment thereto of the handle section.

Typically, the transversal cross-sectional configuration of the stem connecting segment has a substantially oval shape defining a major axis and a minor axis, the major axis being oriented so as to extend substantially between front and rear edges of the stem outer wall.

Conveniently, the stem section also includes a stem attachment segment located intermediate the stem distal end and the bending moment compensating segment for allowing attachment thereto of the sole section.

Typically, the stem section still further includes a stem spacing segment located intermediate the stem connecting and bending moment compensating segments for spacing the latter.

Conveniently, the transversal cross-sectional configuration of the stem connecting segment has a substantially oval shape defining a major axis and a minor axis, the major axis being oriented so as to extend substantially between the front and rear edges of the stem outer wall, in a direction leading from the stem connecting segment to the stem spacing segment, the overall circumference of the stem section increasing with the rate of increase ratio of the minor axis being greater than that of the major axis.

In accordance with the present invention, there is also provided a walking cane for at least partially supporting the weight of the intended user as the latter is walking, the walking cane comprising: a handle section for allowing grasping of the cane, a sole section for engaging the ground surface and a stem section extending between the handle section and the sole section; the handle section; the handle section projecting substantially forwardly from the stem section, the handle section having a generally elongated configuration defining a handle longitudinal axis, a handle rear end located adjacent the stem section and a longitudinally opposed handle front end; the stem section having a generally elongated configuration defining a stem longitudinal axis, a stem proximal end located adjacent the handle section and a stem distal end located adjacent the sole section; the stem having a substantially continuous stem outer wall, the stem section being configured such that when seen from a side view, the stem section outer wall is wider adjacent the stem distal end then adjacent the stem proximal end.

Typically, the stem section is configured such that when seen from a front and rear view, the stem section outer wall is wider adjacent the stem distal end then adjacent the stem proximal end.

Conveniently, the stem outer wall defines a stem front edge and a stem rear edge, the stem outer wall being configured such that the stem longitudinal axis is substantially centered relative to the stem front and rear edges adjacent the stem proximal end and such that the stem longitudinal axis is offset towards the stem rear edge and away from the stem front edge adjacent the stem distal end.

Typically, the stem outer wall defines a stem front edge and a stem rear edge; the stem front edge flaring frontwardly substantially adjacent the stem distal end.

Conveniently, the stem outer wall defines a stem front edge and a stem rear edge; the stem rear edge flaring rearwardly substantially adjacent the stem distal end.

Typically, the stem outer wall defines a stem front edge and a stem rear edge; the stem front edge flaring frontwardly substantially adjacent the stem distal end; the stem rear edge flaring rearwardly substantially adjacent the stem distal end.

Conveniently, the stem front edge flares frontwardly over a front flaring distance and the stem rear edge flares rearwardly over a rear flaring distance, the front flaring distance being greater then the rear flaring distance adjacent the stem distal end so that the stem longitudinal axis is offset towards the stem rear edge adjacent the stem distal end.

Typically, the stem outer wall defines a stem distal edge, the stem distal edge having a substantially convex configuration when seen from a side view.

Conveniently, the stem outer wall defines a stem distal edge, the stem distal edge having a substantially convex configuration when seen from a side view.

Typically, the stem outer wall defines a stem distal edge, the stem distal edge having a substantially concave configuration when seen from a front view.

Conveniently, the stem outer wall defines a stem distal edge, the stem distal edge having a substantially convex configuration when seen from a side view and a substantially concave configuration when seen from a front view.

In accordance with the present invention, there is further provided a walking cane for at least partially supporting the weight of an intended user as the latter is walking, the intended user transmitting to the cane an applied force during use thereof, the applied force having a substantially vertical vector component, the walking cane comprising: a handle section for allowing grasping of the cane, a sole section for engaging the ground surface and a stem section extending between the handle section and the sole section; the handle section, the sole section and the stem section together defining a cane center of gravity; the stem section having a generally elongated configuration defining a stem longitudinal axis, a stem proximal end located adjacent the handle section and a stem distal end located adjacent the sole section; the handle section having a generally elongated configuration defining a handle longitudinal axis, a handle rear end located adjacent the stem section and a longitudinally opposed handle front end; the handle section, the stem section and the sole section being configured and sized so that the stem longitudinal axis is substantially in register with the cane center of gravity when the cane is in a substantially vertical orientation and so that the vector component is in a substantially collinear relationship with the stem longitudinal axis.

Typically, the stem section is substantially hollow. Conveniently, the transversal cross-sectional configuration of the stem adjacent the stem proximal end has a substantially oval shape defining a major axis and a minor axis, the major axis being oriented so as to extend substantially between front and rear edges of the stem outer wall; the stem longitudinal axis being substantially in register with the intersection between the major and minor axes.

Typically, the sole section has a generally elongated configuration defining a sole longitudinal axis, a sole rear end, a longitudinally opposed sole front end and a pair of sole side ends extending therebetween.

Advantages of the present invention include that the proposed walking cane is provided with a handle section designed so as to reduce the stress concentration on the patient's body parts by positioning the handle in an optimum ergonomic position relative to the anatomical center of the human shoulder.

Also, the proposed walking cane is provided with a handle section designed so that the forces bearing on the patient's body parts are evenly distributed thereby helping the intended user to control and distribute the weight of the disabled limb as needed.

Furthermore, the proposed walking cane is provided with a handle section allowing the intended user to grab the handle from either the right or left hand while also providing improved ergonomic features on both sides.

Also, the proposed walking cane is provided with a tip section intended to increase both static and dynamic stability on various types of ground surfaces. The proposed walking cane further optionally allows an intended user to customize the type of ground engaging tip depending on the type of settings in which the cane is to be used.

Still furthermore, the proposed walking cane is designed so as to provide optimized structural characteristic taking into consideration parameters such as moment of inertia, weight and distribution of the center of gravity.

Also, the proposed walking cane is designed so as to be aesthetically pleasing to the eye while providing improved functionality.

Furthermore, the proposed walking cane is designed so as to promote comfortable, balanced and ergonomic weight distribution. Also, the proposed walking cane is designed so as to be able to stand erect in a generally upright position when settled on a generally horizontal surface.

Still furthermore, the proposed walking cane is adapted to be manufactured using conventional forms of manufacturing so as to provide a walking cane that will be economically feasible, long lasting and relatively trouble free in operation.

### BRIEF DESCRIPTION OF THE DRAWINGS

Various embodiments of the present invention will now be disclosed, by way of example, in reference to the following drawings in which:

FIG. 1: in a schematic side elevational view, illustrates a conventional prior art cane.

FIG. 2: in a schematic side elevational view, illustrates the conventional prior art cane of FIG. 1 being deflected by a vertical force applied on its handle section.

FIG. 3: in a front perspective view, illustrates a walking cane in accordance with an embodiment of the present invention.

FIG. 4: in a side elevational view, illustrates the walking cane shown in FIG. 3 having a vertical force applied thereon.

FIG. 5: in an exploded view, illustrates a walking cane in accordance with an embodiment of the present invention with various possible embodiments of sole components and color components attachable thereto.

FIG. 6: in a perspective view, illustrates a stem component, part of a walking cane, in accordance with an embodiment of the present invention.

FIG. 7: in a front view, illustrates the stem component shown in FIG. 6.

FIG. 8: in a side elevational view, illustrates the stem component shown in FIG. 6 and 7.

FIG. 9: in a rear view, illustrates the stem component shown in FIGS. 6 through 8.

FIG. 10: in a bottom view, illustrates the stem component shown in FIGS. 7 through 9.

FIG. 11: in a partial side view with sections taken out, illustrates an abutment section part of the stem component shown in FIGS. 6 through 10.

FIG. 12: in a partial side elevational view with sections taken out, illustrates a sole anchoring section, part of the stem component shown in FIGS. 6 through 10.

FIG. 13: in a transversal cross sectional view taken along arrows 13-13 of FIG. 8, illustrates the cross sectional configuration of the stem component shown in FIGS. 6 through 10 at the level of arrow 13-13.

FIG. 14: in a transversal cross sectional view taken along arrows 14-14 of FIG. 8, illustrates the cross sectional configuration of the stem component shown in FIGS. 6 through 10 at the level of arrow 14-14.

FIG. 15: in a transversal cross sectional view taken along arrows 15-15 of FIG. 8, illustrates the cross sectional configuration of the stem component shown in FIGS. 6 through 10 at the level of arrow 15-15.

FIG. 16: in a transversal cross sectional view taken along arrows 16-16 of FIG. 8, illustrates the cross sectional configuration of the stem component shown in FIGS. 6 through 10 at the level of arrow 16-16.

FIG. 17: in a transversal cross sectional view taken along arrows 17-17 of FIG. 8, illustrates the cross sectional configuration of the stem component shown in FIGS. 6 through 10 at the level of arrow 17-17.

FIG. 18: in a transversal cross sectional view taken along arrows 18-18 of FIG. 8, illustrates the cross sectional configuration of the stem component shown in FIGS. 6 through 10 at the level of arrow 18-18.

FIG. 19: in a transversal cross sectional view taken along arrows 19-19 of FIG. 8, illustrates the cross sectional configuration of the stem component shown in FIGS. 6 through 10 at the level of arrow 19-19.

FIG. 20: in a transversal cross sectional view taken along arrows 20-20 of FIG. 8, illustrates the cross sectional configuration of the stem component shown in FIGS. 6 through 10 at the level of arrow 20-20.

FIG. 21: in a longitudinal cross sectional view taken along arrows 21-21 of FIG. 10, illustrates the longitudinal cross sectional configuration of the stem component shown in FIGS. 6 through 10 at the level of arrow 21-21.

FIG. 22: in a longitudinal cross sectional view, illustrates the configuration of a walking cane in accordance with an alternative embodiment of the present invention.

FIG. 23: in a longitudinal cross sectional view, illustrates the configuration of the walking cane embodiment shown in FIG. 22.

FIG. 24: in a front perspective view, illustrates a handle component part of a walking cane in accordance with an embodiment of the present invention.

FIG. 25: in a rear perspective view, illustrates a handle component part of a walking cane in accordance with an embodiment of the present invention.

FIG. 26: in a top view, illustrates a handle component part of a walking cane in accordance with an embodiment of the present invention.

FIG. 27: in a front view, illustrates a handle component part of a walking cane in accordance with an embodiment of the present invention.

FIG. 28: in a side view, illustrates a handle component part of a walking cane in accordance with an embodiment of the present invention.

FIG. 29: in a rear view, illustrates a handle component part of a walking cane in accordance with an embodiment of the present invention.

FIG. 30: in a transversal cross sectional view taken along arrow 30-30 of FIG. 28, illustrates a cross section configuration of the handle component shown in FIG. 28 at the location indicated by arrow 30-30.

FIG. 31: in a longitudinal cross section view taken along arrows 31-31 of FIG. 29, illustrates a cross sectional configuration of the handle component shown in FIG. 29 at the location indicated by arrow 31-31.

FIG. 32: in a transversal cross sectional view taken along arrow 32-32 of FIG. 28, illustrates a cross section configuration of the handle component shown in FIG. 28 at the location indicated by arrow 32-32.

FIG. 33: in a transversal cross sectional view taken along arrow 33-33 of FIG. 28, illustrates a cross section configuration of the handle component shown in FIG. 28 at the location indicated by arrow 33-33.

FIG. 34: in a transversal cross sectional view taken along arrow 34-34 of FIG. 28, illustrates a cross section configuration of the handle component shown in FIG. 28 at the location indicated by arrow 34-34.

FIG. 35: in a transversal cross sectional view taken along arrow 35-35 of FIG. 28, illustrates a cross section configuration of the handle component shown in FIG. 28 at the location indicated by arrow 35-35.

FIG. 36: in a transversal cross sectional view taken along arrow 36-36 of FIG. 28, illustrates a cross section configuration of the handle component shown in FIG. 28 at the location indicated by arrow 36-36.

FIG. 37: in a transversal cross sectional view taken along arrow 37-37 of FIG. 28, illustrates a cross section configuration of the handle component shown in FIG. 28 at the location indicated by arrow 37-37.

FIG. 38: in a side view, illustrates the configuration of a handle component in accordance with an alternative embodiment of the invention.

FIG. 39: in a front view, illustrates the configuration of the handle in accordance with the alternative embodiment of the invention shown in FIG. 38.

FIG. 40: in a side view, illustrates the opposite side of the configuration of the handle shown in FIGS. 38 and 39.

FIG. 41: in a rear view, illustrates the configuration of the handle shown in FIGS. 38 through 40.

FIG. 42: in a longitudinal cross sectional view taken along arrows 42-42 of FIG. 22, illustrates the cross sectional configuration of the handle shown in FIG. 40 at the location shown by arrows 42-42.

FIG. 43: in a longitudinal cross sectional view taken along arrows 43-43 of FIG. 22, illustrates the cross sectional configuration of the handle shown in FIG. 40 at the location shown by arrows 43-43.

FIG. 44: in a longitudinal cross sectional view taken along arrows 44-44 of FIG. 22, illustrates the cross sectional configuration of the handle shown in FIG. 40 at the location shown by arrows 44-44.

FIG. 45: in a longitudinal cross sectional view taken along arrows 45-45 of FIG. 22, illustrates the cross sectional configuration of the handle shown in FIG. 40 at the location shown by arrows 45-45.

FIG. 46: in a longitudinal cross sectional view taken along arrows 46-46 of FIG. 22, illustrates the cross sectional configuration of the handle shown in FIG. 40 at the location shown by arrows 46-46.

FIG. 47: in a longitudinal cross sectional view taken along arrows 47-47 of FIG. 22, illustrates the cross sectional configuration of the handle shown in FIG. 40 at the location shown by arrows 47-47.

FIG. 48: in a transversal cross section view taken along arrows 48-48 of FIG. 40, illustrates the transversal cross sectional configuration of the handle shown in FIG. 40 at the location shown by arrows 48-48.

FIG. 49: in a transversal cross section view taken along arrows 49-49 of FIG. 41, illustrates the cross sectional configuration of the handle shown in FIG. 41.

FIG. 50: in a top view, illustrates the configuration of the alternative embodiment of the handle shown in FIGS. 38 through 49.

FIG. 51: in a schematic side view, illustrates the configuration of the handle shown in FIGS. 38 through 50.

FIG. 52: in a rear view, illustrates a locking pin part of a walking cane in accordance with an embodiment of the present invention.

FIG. 53: in a front perspective view, illustrates the locking pin shown in FIG. 52.

FIG. 54: in a rear perspective view, illustrates the locking pin shown in FIGS. 52 and 53.

FIG. 55: in a side view, illustrates the locking pin shown in FIGS. 52 through 54.

FIG. 56: in an elevational view, illustrates the locking pin shown in FIGS. 52 through 55.

FIG. 57: in an elevational view, illustrates a biasing spring part of the walking cane in accordance with an embodiment of the present invention.

FIG. 58: in a top view, illustrates the biasing spring shown in FIG. 57.

FIG. 59: in a cross sectional view taken along arrows 59-59 of FIG. 57, illustrates the cross sectional configuration of the biasing spring shown in FIGS. 57 and 58.

FIG. 60: in a rear perspective view, illustrates a clip component part of a walking cane in accordance with an embodiment of the present invention. The clip component being shown in a closed configuration.

FIG. 61: in an opposed rear perspective view, illustrates the clip component shown in FIG. 60.

FIG. 62: in a perspective view, illustrates the clip component shown in FIGS. 60 and 61 in an intermediate configuration.

FIG. 63: in an opposed rear perspective view, illustrates the clip component shown in FIG. 62.

FIG. 64: in a rear perspective view, illustrates the clip component shown in FIG. 60 through 63 in an opened configuration.

FIG. 65: in an opposed rear perspective view, illustrates the clip component shown in FIG. 64.

FIG. 66: in an exploded view, illustrates the clip component shown in FIGS. 60 through 65.

FIG. 67: in a partial top view with sections taken out, illustrates part of the locking mechanism of the clip component shown in FIGS. 60 through 66.

FIG. 68: in a side view, illustrates a linking arm, part of the clip component shown in FIGS. 60 through 67.

FIG. 69: in an elevational view, illustrates the linking arm shown in FIG. 68.

FIG. 70: in a top view, illustrates the linking arm shown in FIGS. 68 and 69.

FIG. 71: in a front view, illustrates a tongue component, part of the clip component shown in FIGS. 60 through 70.

FIG. 72: in a top view, illustrates the tongue component shown in FIG. 71.

FIG. 73: in a side view, illustrates the tongue component shown in FIG. 71.

FIG. 74: in a front perspective view, illustrates the tongue component in FIGS. 71 through 73.

FIG. 75: in a rear view, illustrates the tongue component shown in FIGS. 71 and 73.

FIG. 76: in a rear perspective view, illustrates the tongue component shown in FIGS. 71 through 75.

FIG. 77: in a front perspective view, illustrates a clip component in accordance with an embodiment of the present invention.

FIG. 78: in a front perspective view, illustrates a clip component in accordance with a second embodiment of the present invention.

FIG. 79: in a perspective view, illustrates a clip component in accordance with a third embodiment of the present invention.

FIG. 80: in a front view, illustrates the clip component shown in FIG. 77.

FIG. 81: in a top view, illustrates the clip component shown in FIG. 77

FIG. 82: in a side view, illustrates the clip component shown in FIGS. 77 and 80.

FIG. 83: in a side perspective view, illustrates the clip component shown in FIGS. 80 through 82.

FIG. 84: in a top perspective view, illustrates the clip component shown in FIGS. 80 through 83.

FIG. 85: in a front view, illustrates the clip component shown in FIG. 79.

FIG. 86: in a top view, illustrates the clip component shown in FIGS. 79 and 85.

FIG. 87: in a side perspective view, illustrates the clip component shown in FIGS. 85 and 86.

FIG. 88: in a side elevational view, illustrates the clip component shown in FIGS. 85 through 87.

FIG. 89: in a top perspective view, illustrates the clip component shown in FIGS. 85 through 88.

FIG. 90: in a front view, illustrates the clip component shown in FIG. 78.

FIG. 91: in a top view, illustrates the clip component shown in FIGS. 78 and 90.

FIG. 92: in a side elevational view, illustrates the clip component shown in FIGS. 90 AND 91.

FIG. 93: in a side perspective view, illustrates the clip component shown in FIGS. 90 through 92.

FIG. 94: in a top perspective view, illustrates the clip component shown in FIGS. 90 through 93.

FIG. 95: in a bottom perspective view, illustrates a sole component in accordance with a first embodiment of the present invention.

FIG. 96: in a top perspective view, illustrates the sole component shown in FIG. 95.

FIG. 97: in a top view, illustrates the sole component shown in FIGS. 95 and 96.

FIG. 98: in a rear view, illustrates the sole component shown in FIGS. 95 through 97.

FIG. 99: in a side elevational view, illustrates the sole component shown in FIGS. 95 through 98.

FIG. 100: in a front view, illustrates the sole component shown in FIGS. 95 through 99.

FIG. 101: in a bottom view, illustrates the sole component shown in FIGS. 95 through 100.

FIG. 102: in a transversal cross sectional view taken along arrows 102-102 of FIG. 99 illustrates the cross sectional configuration of the sole shown in FIG. 99 taken along arrows 102-102.

FIG. 103: in a transversal cross sectional view taken along arrows 103-103 of FIG. 99 illustrates the cross sectional configuration of the sole shown in FIG. 99 taken along arrows 103-103.

FIG. 104: in a transversal cross sectional view taken along arrows 104-104 of FIG. 99 illustrates the cross sectional configuration of the sole shown in FIG. 99 taken along arrows 104-104.

FIG. 105: in a transversal cross sectional view taken along arrows 105-105 of FIG. 99 illustrates the cross sectional configuration of the sole shown in FIG. 99 taken along arrows 105-105.

FIG. 106: in a transversal cross sectional view taken along arrows 106-106 of FIG. 99 illustrates the cross sectional configuration of the sole shown in FIG. 99 taken along arrows 106-106.

FIG. 107: in a transversal cross sectional view taken along arrows 107-107 of FIG. 99 illustrates the cross sectional configuration of the sole shown in FIG. 99 taken along arrows 107-107.

FIG. 108: in a transversal cross sectional view taken along arrows 108-108 of FIG. 99 illustrates the cross sectional configuration of the sole shown in FIG. 99 taken along arrows 108-108.

FIG. 109: in a longitudinal cross sectional view taken along arrows 109-109 of FIG. 97, illustrates the configuration of the sole component shown in FIG. 97.

FIG. 110: in a bottom perspective view, illustrates the configuration of the sole component in accordance with the second embodiment of the present invention.

FIG. 111: in a top view, illustrates the configuration of the sole component shown in FIG. 110.

FIG. 112: in a top view, illustrates the configuration of the sole component shown in FIGS. 110 and 111.

FIG. 113: in a rear view, illustrates the configuration of the sole component shown in FIGS. 110 through 112.

FIG. 114: in a side elevational view, illustrates the configuration of the sole component shown in FIGS. 110 through 113.

FIG. 115: in a front view, illustrates the configuration of the sole component shown in FIGS. 110 through 114.

FIG. 116: in a bottom view, illustrates the configuration of the sole component shown in FIGS. 110 through 115.

FIG. 117: in a transvetsal cross sectional view taken along arrows 117-117 of FIGS. 114, illustrates the configuration of the sole component shown in FIG. 114 taken along arrows 117-117.

FIG. 118: in a transversal cross sectional view taken along arrows 118-118 of FIGS. 114, illustrates the configuration of the sole component shown in FIG. 114 taken along arrows 118-118.

FIG. 119: in a transversal cross sectional view taken along arrows 119-119 of FIGS. 114, illustrates the configuration of the sole component shown in FIG. 114 taken along arrows 119-119.

FIG. 120: in a transversal cross sectional view taken along arrows 120-120 of FIGS. 114, illustrates the configuration of the sole component shown in FIG. 114 taken along arrows 120-120.

FIG. 121: in a transversal cross sectional view taken along arrows 121-121 of FIGS. 114, illustrates the configuration of the sole component shown in FIG. 114 taken along arrows 121-121.

FIG. 122: in a transversal cross sectional view taken along arrows 122-122 of FIGS. 114: illustrates the configuration of the sole component shown in FIG. 114 taken along arrows 122-122.

FIG. 123: in a transversal cross sectional view taken along arrows 123-123 of FIGS. 114: illustrates the configuration of the sole component shown in FIG. 114 taken along arrows 123-123.

FIG. 124: in a longitudinal cross sectional view taken along arrows 124-124 of FIG. 112, illustrates the configuration of the sole component shown in FIGS. 112 taken along arrows 124-124.

FIG. 125: in a bottom perspective view, illustrates an anti slip component optionally part of the present invention.

FIG. 126: in a top perspective view, illustrates the anti slip component shown in FIG. 125.

FIG. 127: in a top view, illustrates the anti slip component shown in FIGS. 125 and 126.

FIG. 128: in a side elevational view, illustrates the anti slip component shown in FIGS. 125 through 127.

FIG. 129: in a bottom view, illustrates the anti slip component shown in FIGS. 125 through 128.

FIG. 130: in a front view, illustrates the anti slip component shown in FIGS. 125 through 129.

FIG. 131: in a rear view, illustrates the anti slip component shown in FIGS. 125 through 130.

FIG. 132: in a perspective view, illustrates a clipping component (forward), part of the anti-slip component shown in FIGS. 125 through 131.

FIG. 133: in a perspective view, illustrates a second clipping component (rear), part of the anti-slip component shown in FIGS. 125 through 131.

FIG. 134: in a side elevational view, illustrates the anti slip component mounted on the sole component shown in FIGS. 110 through 124.

FIG. 135: in a side elevational view, illustrates the anti slip component mounted on the sole component shown in FIGS. 95 through 109.

FIG. 136: is a palmar view of the anatomy of the human right wrist and right hand.

FIG. 137: in a top view, illustrates a clip component in accordance with a fourth embodiment of the present invention.

FIG. 138: in a front view, illustrates the clip component shown in FIG. 137.

FIG. 139: in a side view, illustrates the clip component shown in FIGS. 137 and 138.

FIG. 140: in a rear exploded view, illustrates the clip component shown in FIGS. 137 through 139.

FIG. 141: in a top view, illustrates a fixed link component in accordance with a fourth embodiment of the clip of the present invention.

FIG. 142: in a front view, illustrates the fixed link component shown in FIG. 141.

FIG. 143: in a side view, illustrates the fixed link component shown in FIGS. 141 and 142.

FIG. 144: in a rear perspective view, illustrates the clip component shown in FIGS. 141 through 143.

FIG. 145: in a front perspective view, illustrates the clip component shown in FIGS. 141 through 144.

FIG. 146: in a bottom view, illustrates the configuration of the sole component in accordance with the third embodiment of the present invention.

FIG. 147: in a bottom perspective view, illustrates the configuration of the sole component in accordance with the third embodiment of the present invention shown in FIGS. 146.

FIG. 148: in a top perspective view, illustrates the configuration of the sole component in accordance with the third embodiment of the present invention shown in FIGS. 146 through 147.

FIG. 149: in a top view, illustrates the configuration of the sole component in accordance with the third embodiment of the present invention shown in FIGS. 146 through 148.

FIG. 150: in a front view, illustrates the configuration of the sole component in accordance with the third embodiment of the present invention shown in FIGS. 146 through 149.

FIG. 151: in a side view, illustrates the configuration of the sole component in accordance with the third embodiment of the present invention shown in FIGS. 146 through 150.

FIG. 152: in a transversal cross sectional view taken along arrows 152-152 of FIGS. 149, illustrates the configuration of the sole component shown in FIG. 149 taken along arrows 152-152.

FIG. 153: : in a side elevation view, illustrates a anti-slip part of the walking cane in accordance with an embodiment of the present invention.

FIG. 154: : in a top view, illustrates a anti-slip part of the walking cane in accordance with an embodiment of the present invention shown in FIG. 153.

FIG. 155: : in a front view, illustrates a anti-slip part of the walking cane in accordance with an embodiment of the present invention shown in FIG. 153 to 154.

FIG. 156: : in a top perspective view, illustrates a anti-slip part of the walking cane in accordance with an embodiment of the present invention shown in FIG. 153 to 155.

FIG. 157: : in a top view, illustrates the configuration of the second embodiment of the locking pin shown in FIGS. 52 through 56.

FIG. 158: : in a side view, illustrates the configuration of the second embodiment of the locking pin shown in FIGS. 157.

FIG. 159: : in a side view, illustrates the configuration of the second embodiment of the locking pin shown in FIGS. 157 and FIG. 158.

FIG. 160: : in a top perspective view, illustrates the configuration of the second embodiment of the locking pin shown in FIGS. 157 through 159.

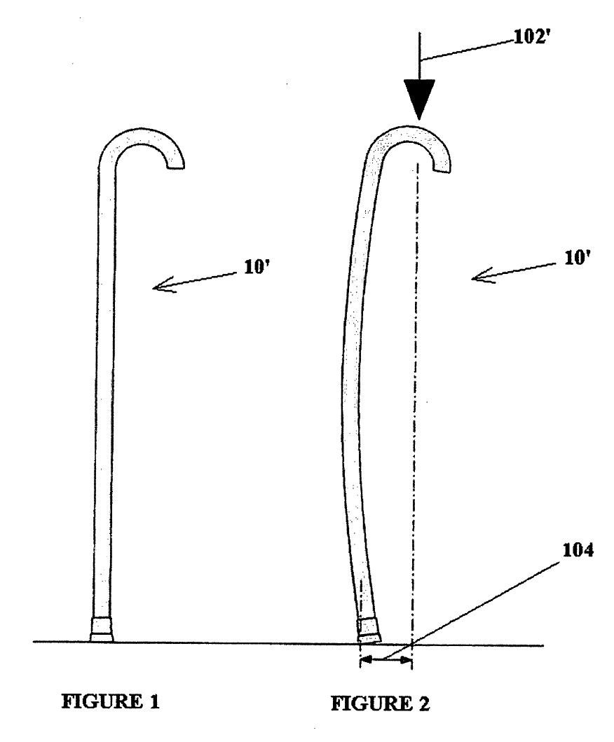

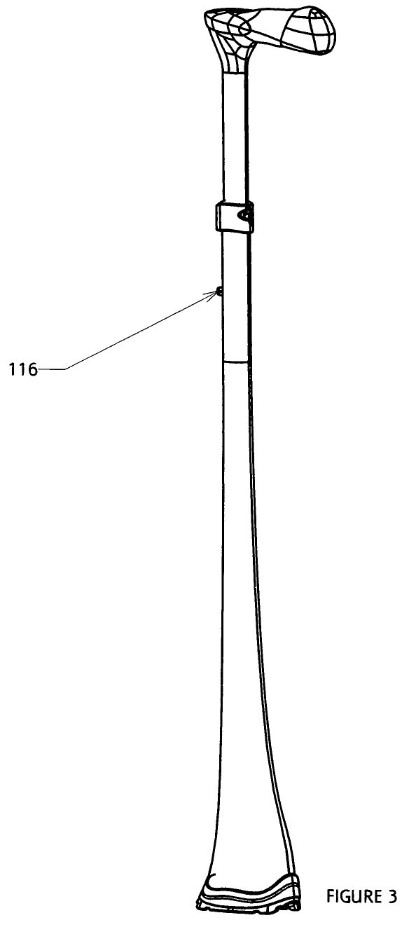

### DETAILED DESCRIPTION

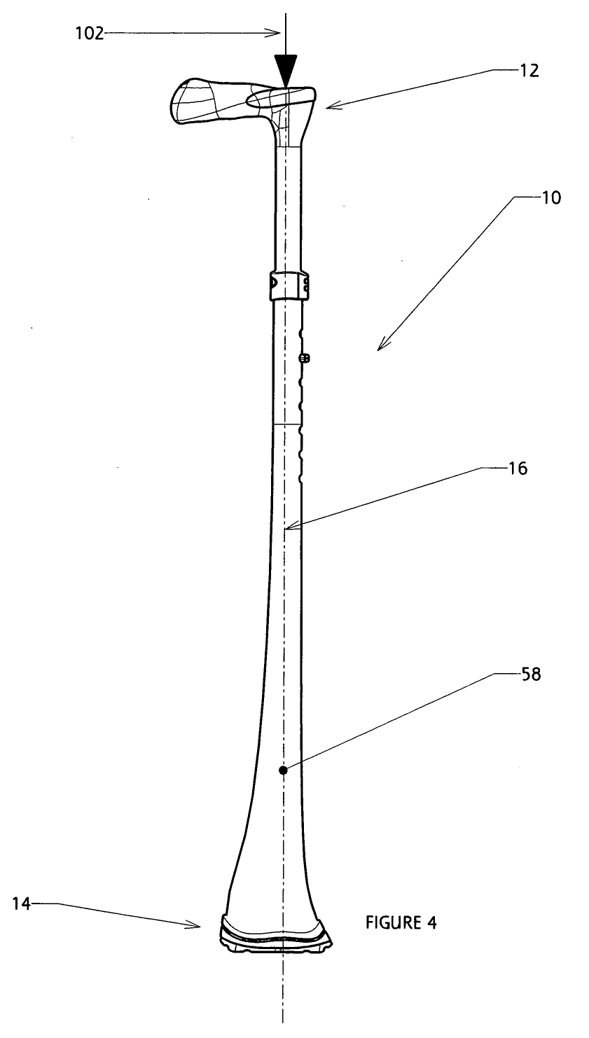

Referring to FIG. 4, there is shown a walking cane (10) in accordance with an embodiment of the present invention. The walking cane (10) has a generally elongated configuration defining a cane first or proximal end (12), a cane second or distal end (14) and a cane longitudinal axis (16) extending therebetween.

As is well known in the art, the cane (10) is provided with a grasping means positioned adjacent the cane first end (12) for allowing an intended user to grasp the cane (10) and a ground engaging means positioned adjacent of the cane second longitudinal end (14) for engaging a ground surface during use. The cane (10) is further provided with a spacing means extending between the grasping and ground engaging means for maintaining the latter in a predetermined spaced relationship relative to each other.

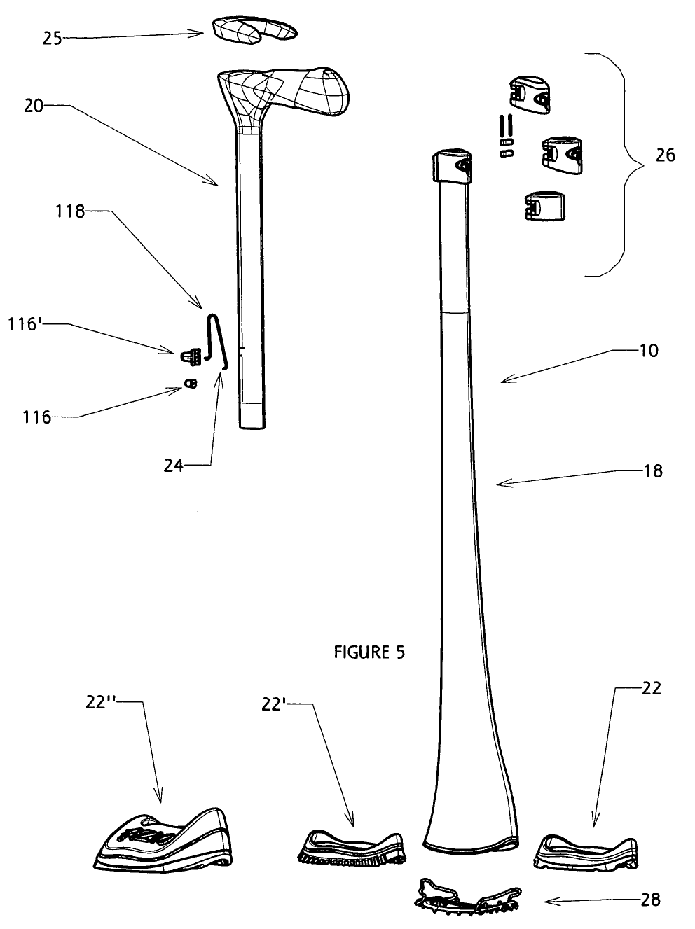

In the embodiments shown throughout the FIGS., the cane (10) is shown as being made out of separate components assembled together. It should however be understood that the cane (10) could be made of an integral piece of material or formed of independent components otherwise assembled without departing from the scope of the present invention. In a preferred embodiment of the invention shown in FIG. 5, the cane (10) includes a leg or stem component (18), a handle component (20) attachable to the stem component (18) and a sole or ground engaging component (22) attachable to the stem component (18) generally opposite the handle component (20).

The cane (10) is typically also provided with a handle-to-stem attachment means (24) for preferably releasably attaching the handle component (20) to the stem component (18). Preferably, the handle-to-stem attachment means (24) includes a length adjustment means for allowing adjustment of the length of the cane (10) about the cane longitudinal axis (16).

Optionally, the cane (10) is further provided with a clipping means (26) mountable between the handle and stem components (20), (18) for clipping the latter together. Also, optionally, the cane (10) is further provided with a friction enhancing means (28) attachable to the stem component (18) and/or sole component (22) for enhancing the friction coefficient with the ground on which the cane component (10) is used. Each separate means or components will now be disclosed in greater details.

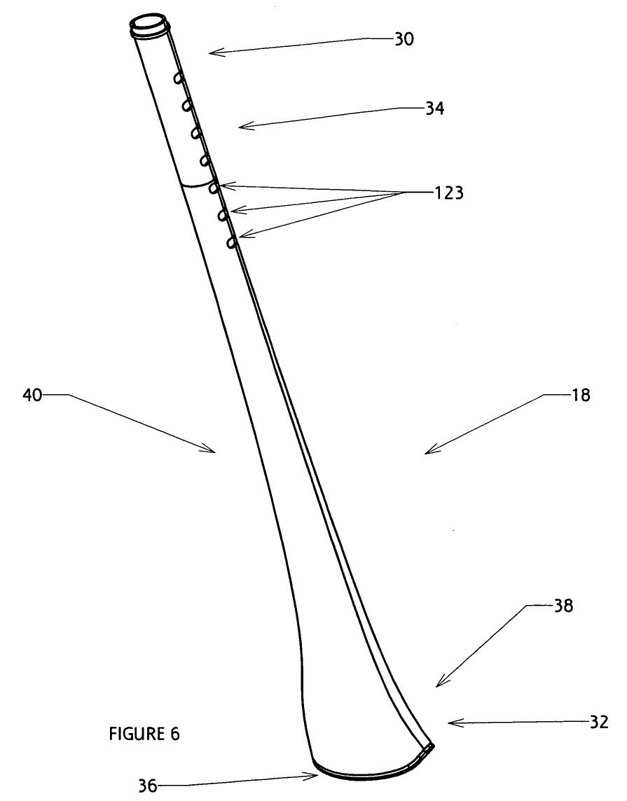

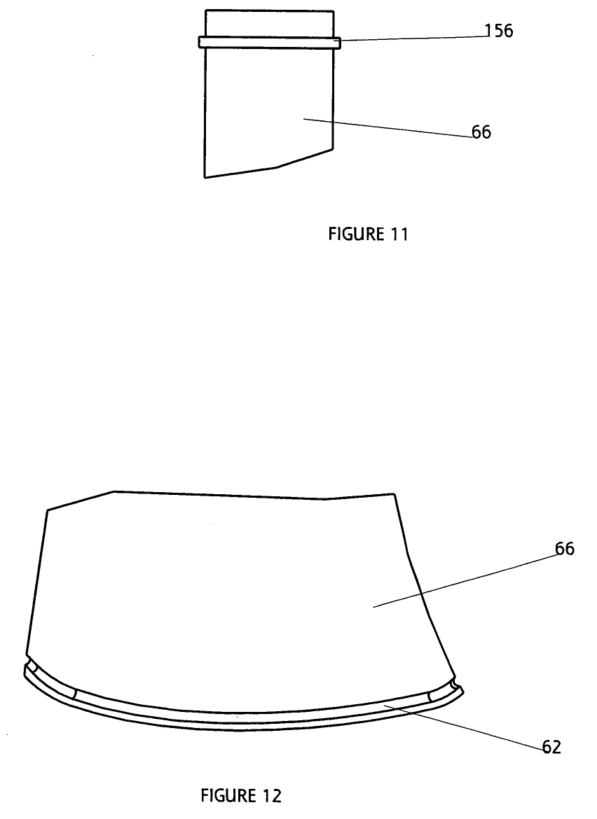

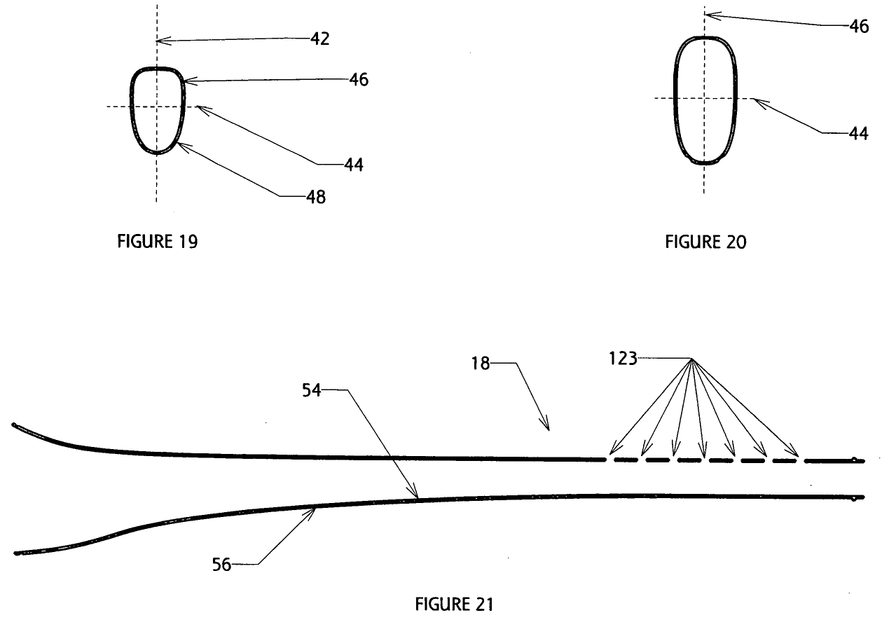

Referring to FIGS. 6 through 21, there is shown in greater details some of the features of the stem component (18). The stem component (18) has a generally elongated configuration defining a stem first or proximal end (30) and an opposed stem second or distal end (32). In relation to the usual substantially uptight position of a walking cane in an operative orientation as employed by the cane user, the cane first end is typically located in an overlying relationship relative to the cane second end (32).

The stem component (18) may be generally described by having a variably-tapered-complex-generally curvy linear shaped since both the cross sectional configuration and the curvature of the stem component (18) varies therealong. The stem component (18) may be generally described as defining a stem connecting segment (34) extending from the stem first end (30) for connecting the stem component (18) to the handle component (20). The stem component (18) also defines a stem attachment section (36) located adjacent the stem second end (32) for allowing attachment of the sole component (22) and/or friction enhancing means (28) thereto.

The stem component (18) generally further defines a bending moment compensating section (38) located substantially adjacent the stem attachment section (36) for compensating the bending moments created in the stem component (18) during use. The stem component (18) still generally further includes a stem spacing segment (40) located between the stem connecting segment (34) and the bending moment compensating segment (38) for spacing the latter.

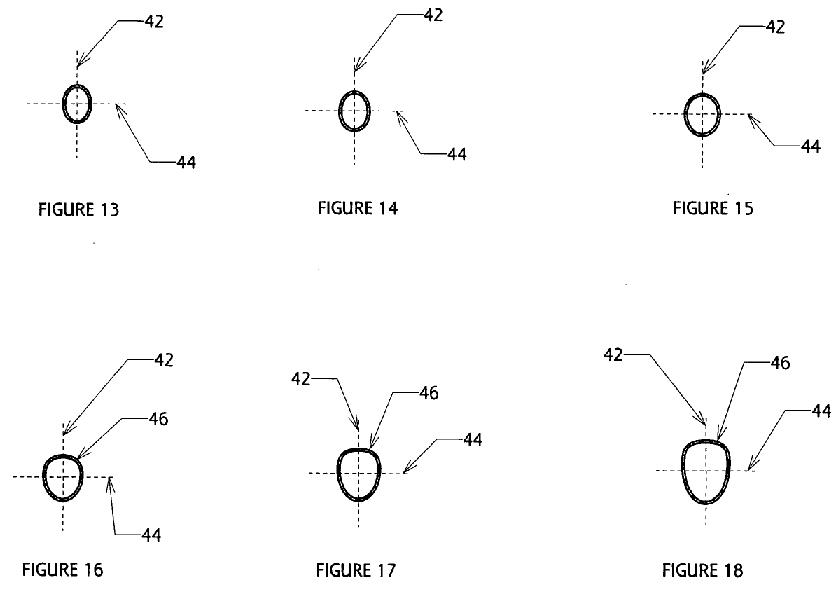

As illustrated more specifically in FIGS. 13 and 14, the transversal cross sectional configuration of the stem connecting section (34) typically has a generally oval shape defining a major axis (42) and a minor axis (44). In a direction leading from the stem connecting segment (34) to the stem spacing segment (40) the overall circumference of the stem component (18) typically increases with an increase ratio of the minor axis (44) relative to the major axis (42) in favor of the minor axis (44), as shown in FIGS. 13 through 15.

Upon reaching an intermediate position generally in register with arrows 15-15 of FIG. 8, the overall circumference of the stem component (18) continues to increase with the rate of increase of the major axis (42) being greater than that of the minor axis (44). Also, an arc segment (46) bisected by the major axis (42) becomes generally flattened so that the transversal cross sectional configuration of the stem component (18) generally assumes a generally bullet-shape.

It should be understood that although the transversal cross sectional configuration of the stem component (18) shown in FIGS. 13 through 20 may be considered as a preferred embodiment of the invention, the cross sectional configuration of the stem component (18) could vary without departing from the scope of the present invention.

When seen in a side elevational view, such as FIG. 8, the configuration of the stem component (18) has a generally constant width in the connecting section (34). The width of the stem component (18) then increases gradually in the stem spacing segment (40) with a curved arc segment (48) located generally opposite the flattened arc segment (46) flaring outwardly.

In the bending moment compensating section (38), the flattened arc segment (46′) recesses inwardly while the arcuate arc segment (48′) bulges outwardly with an increased rate compared to that of the stem spacing segment (40). The flattened and curved arc segments (46′), (48′) hence respectively define a compensating recess (50) and a compensating bulge (52) both typically having a generally curvilinear configuration.

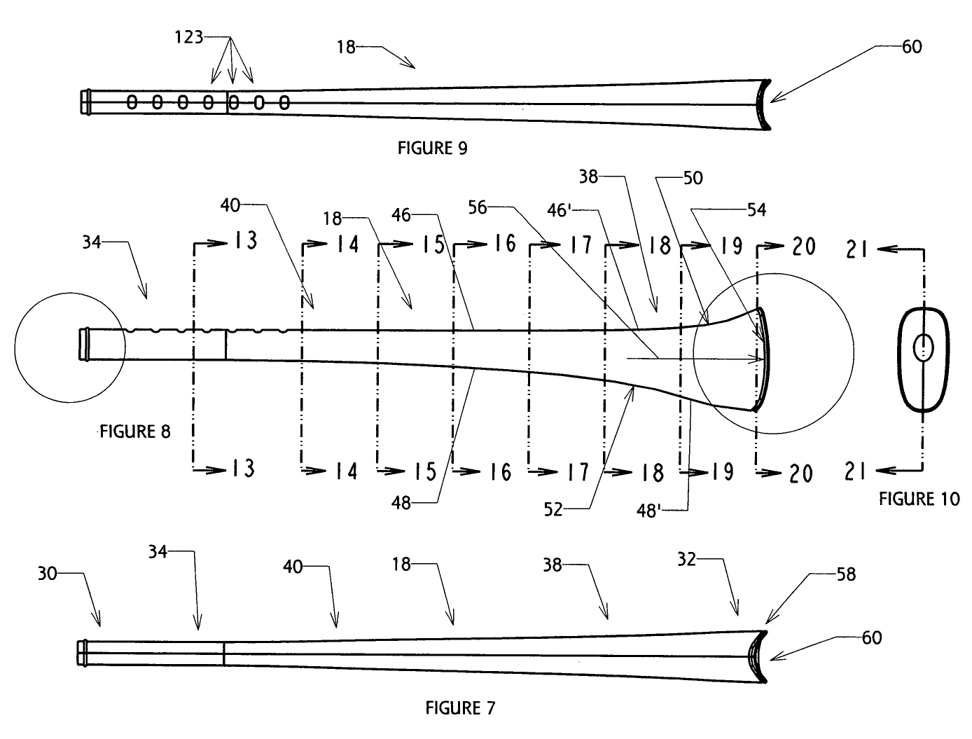

When seen in front and rear views, such as shown respectively in FIGS. 7 and 9, the stem connecting section (34) has a generally constant thickness. The remainder of the stem component (18) has a generally outwardly tapering configuration in a direction leading towards the stem second end (32) so that the thickness of the stem component (18) is generally greater adjacent the stem second end (32) than adjacent the stem first end (30).

As illustrated more specifically in FIGS. 13 through 21, the stem component (18) typically has a generally hollow configuration defining an inner channel (54) generally encompassed by a stem peripheral wall (56). It should be understood that although the stem peripheral wall (56) is shown as having a generally constant thickness at various locations both along the stem (18) and around the circumference of the latter, it should be understood that the thickness of the peripheral wall (56) could vary both along the length of the stem component (18) and around the circumference thereof without departing from the scope of the present invention. Also, some sections of the inner channel (54) may be at least partially or even totally filled with material extending integrally from the peripheral wall (56) without departing from the scope of the present invention.

As illustrated more specifically in FIG. 4, the walking cane (10) typically defines a center of gravity (58) located generally colinearly with the cane longitudinal axis (16). Widening of both the thickness and the depth of the stem component (18) from the stem connecting section (34) to the stem second end (32) allows the center of gravity (58) to remain within the sustentation polygon of the walking cane (10) typically both while the latter remains in a generally upright immobile position when not in use and during use thereof.

The configuration of the stem member (18) hence provides improved static and dynamic stability to the user. The tapering configuration of the stem component (18) also allows the walking cane (10) to be self-standing when rested in a generally vertical orientation on a supporting surface.

The generally constant oval cross sectional configuration of the stem connecting section (34) is intended to facilitate connection of the handle component (20) thereto and telescopic adjustment of the relationship therebetween. The recess and protrusions (50), (52) of the bending moment compensating section (38) are intended to increase structural resistance of the bending moment compensating section (38) against deformation of the stem component (18) caused by bending moments imparted on the latter during use. Typically the curvilinear configuration of the recess and protrusion (50), (52) provides an optimal resistance to bending moments for a given thickness and type of material used for forming the peripheral wall (56).

Typically, the recess (50) is configured and sized so as to provide resistance to bending moments imparted on the stem component (18) when the walking cane (10) contacts the ground surface at generally 30° from a vertical axis. The protuberance (52) is typically configured and sized so as to provide increased structural resistance to bending moments when the cane is pushed backward at the end of a walking sequence.

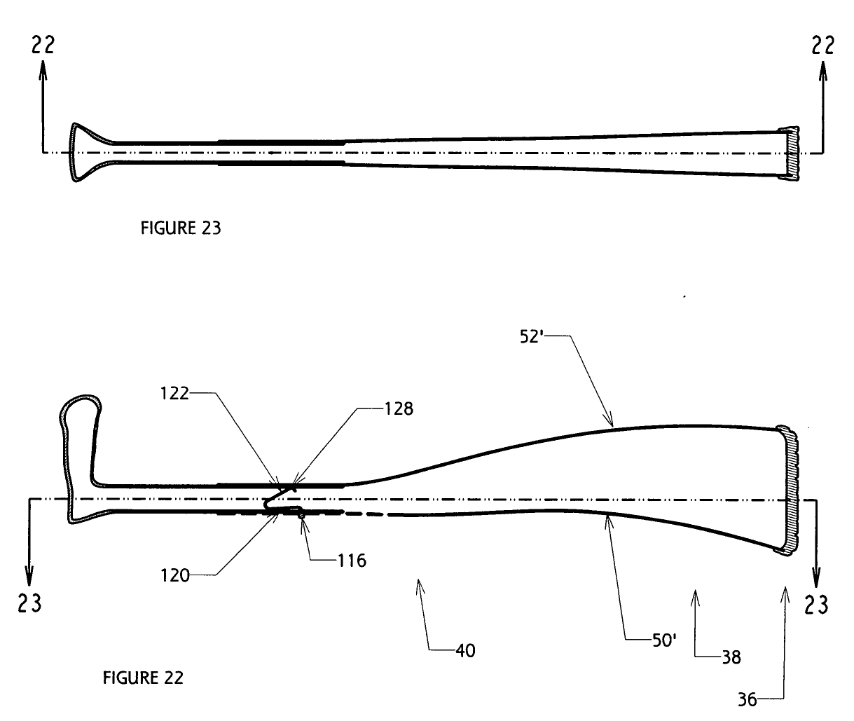

In an alternative embodiment of the invention shown in FIGS. 22 and 23, the recess (50′) and the protuberance (52′) span over a greater distance between the attachment section (36) and the intermediate section (40), the latter being shorter in the previously disclosed embodiment. It should be understood that other configurations of the bending moment compensating section (38) could be used without departing from the scope of the present invention.

As illustrated in FIG. 8, the stem second end (32) typically has a generally arcuate configuration defining an arcuate peripheral edge (54) extending along the segment of a radius of curvature (56) when seen in a side view. When seen in the front and rear views, such as illustrated respectively in FIGS. 7 and 9, the distal end (32) of the stem (18) has generally arcuate or arc-shaped concave edges (58), (60) as will be hereinafter disclosed in greater details.

The stem distal end (32) is provided with a releasable stem attachment means for releasably attaching a sole and/or ice gripping device thereto as illustrated more specifically in FIG. 12. The sole releasable attachment means typically includes a circumferential attachment recess (62) extending circumferentially around the outer surface of the stem (18) adjacent the stem distal end (32). It should be understood that other types of sole attachment means could be used without departing from the scope of the present invention.

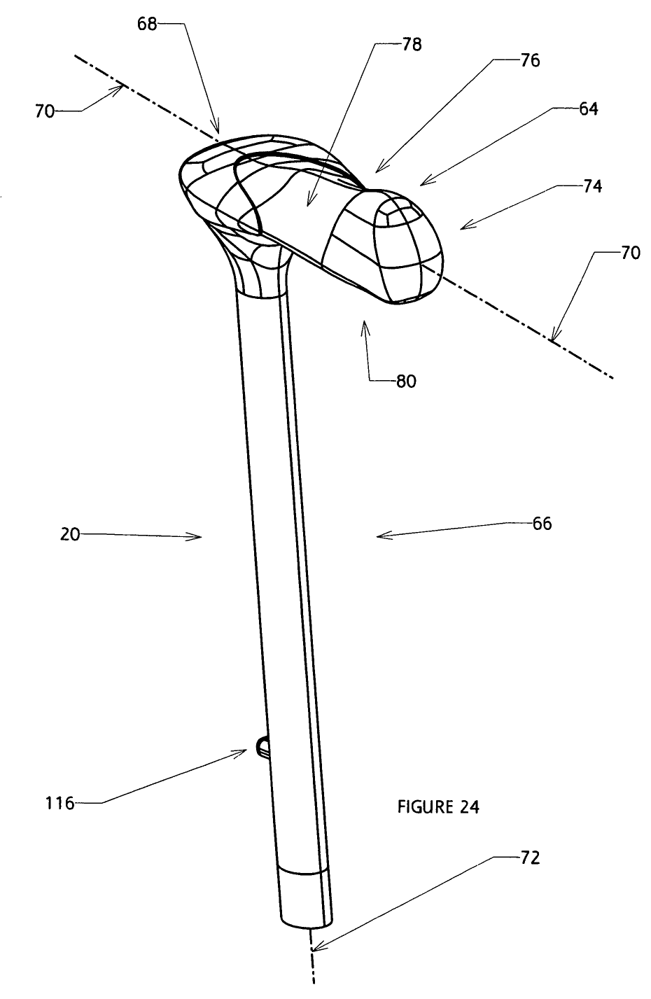

Referring to FIG. 24, there is shown in greater details some features of the handle component (20). The handle component (20) includes a grasping section (64) extending from a shank (66). As will be hereinafter disclosed in greater details, the shank (66) is telescopically insertable and releasably lockable into the stem connecting section (34).

Similarly to the stem component (18), the grasping section (64) may be generally described by having a variably-tapered-complex-curvy linear shape extending generally along a grasping section longitudinal axis (70). The grasping section axis (70), in turn, typically extends generally perpendicularly relative to the shank longitudinal axis (72).

The grasping section (74) may be generally defined as having a proximal segment (68) generally substantially in register with the shank (66), an opposed distal segment (74) and an intermediate segment (76) therebetween. Also, a grasping section (64) may be defined as having a main abutment surface (78) and a generally opposed auxiliary abutment surface (80). In the use of the handle component (20), the proximal segment (68) may be typically referred as being a rearwardly located segment, the distal segment (74) a frontwardly positioned segment, the main abutment surface (78) an upwardly located surface and the auxiliary abutment surface (80) a downwardly located surface.

It should however be understood that the special positioning of the hereinabove mentioned segments and surfaces could vary without departing from the scope of the present invention and it could also vary depending on the relative positioning of the handle component (20), without departing from the scope of the present invention.

As seen more specifically in FIGS. 27 and 29, the main and auxiliary abutment surfaces (78), (80) typically define generally arcuate configurations meeting laterally about a common peripheral surface ridge (82). As shown mote specifically in FIG. 28, the peripheral surface ridge (82) typically slopes from the main abutment surface (78) towards the auxiliary abutment surface (80) in a direction leading from the proximal segment (68) to the distal segment (74), hence defining a generally downwardly sloping configuration when shown in the side view of FIG. 28. The peripheral surface ridge (82) is intended to be used for abuttingly supporting both the thumb and index fingers of the intended user hence preventing the latter from falling off laterally from the main abutment surface (78).

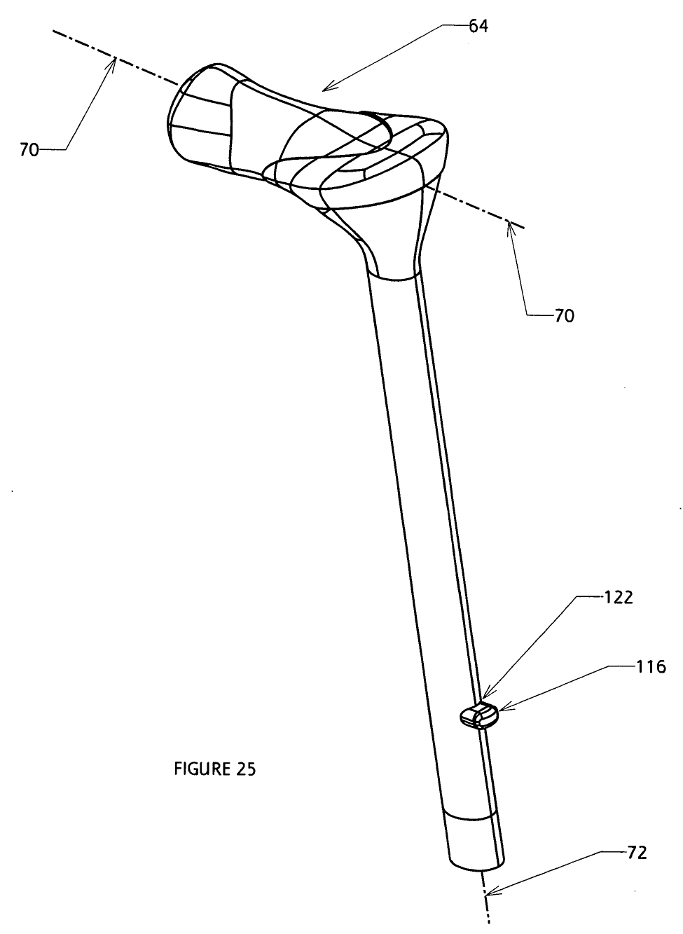

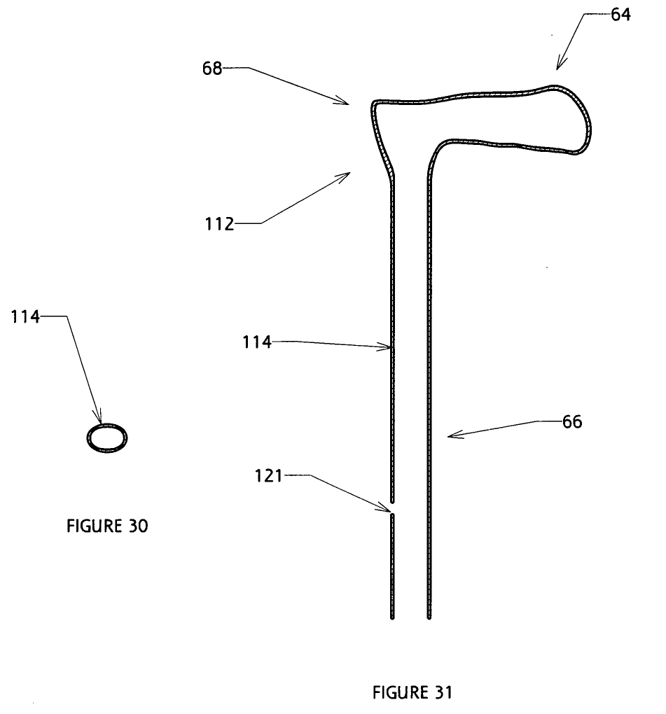

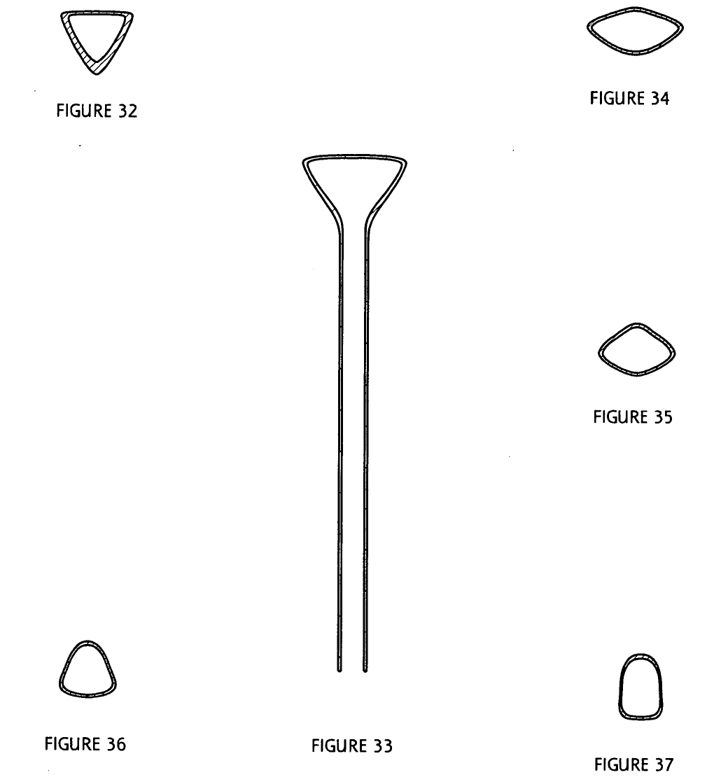

As shown more specifically in FIGS. 27 and 29, the handle component (20) is typically configured so as to be generally symmetrical about the stem axis (72) extending generally colinearly with the cross sectional arrows 31-31 of FIG. 29. Hence, in the embodiment shown in FIGS. 24 through 37, the handle component (20) may be used without any modifications thereto by both right handed and left handed users.

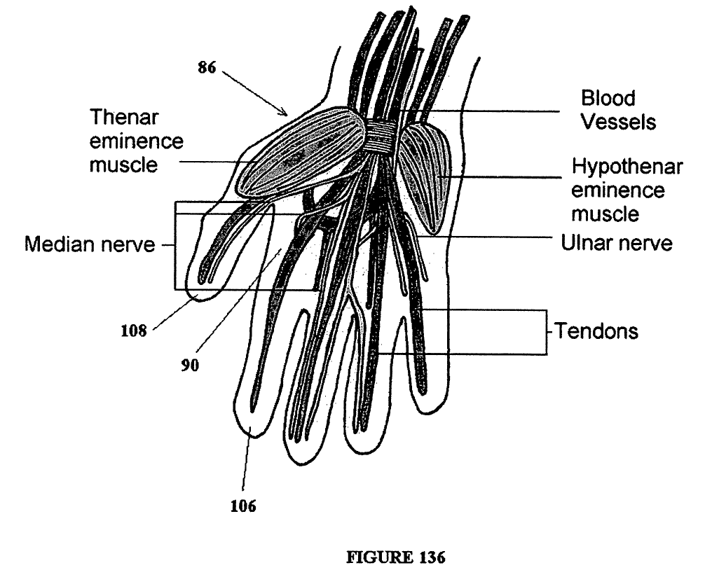

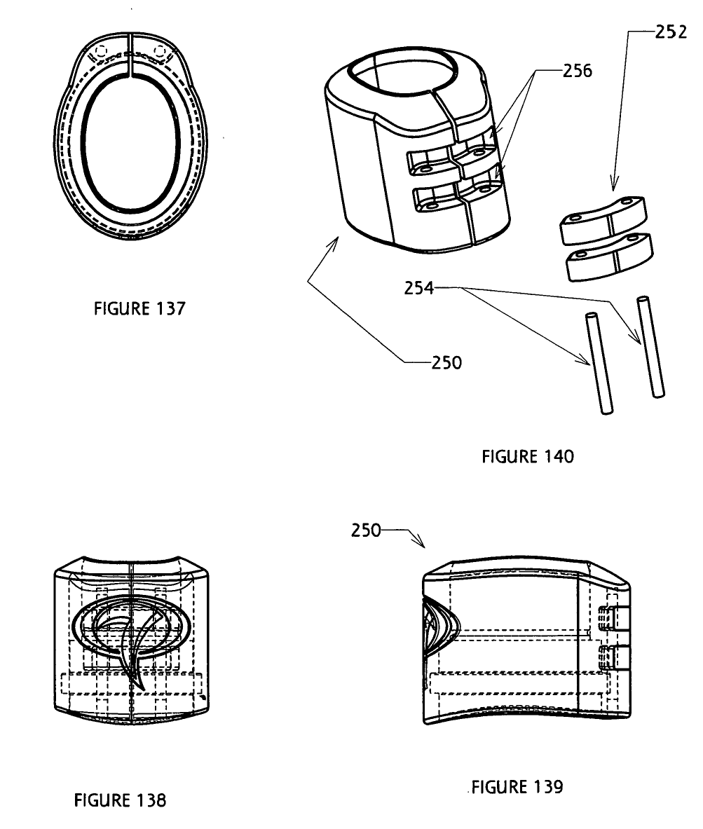

As illustrated more specifically in FIGS. 24 through 26, the main abutment surface (78) typically has a generally pear-shape when seen from a top view. The main abutment surface (78) hence defines a relatively larger proximal palm abutment region (84) for abutting against a proximal region identified by reference numeral (86) in FIG. 136 of the palm of the intended user. The proximal region typically extending from the distal wrist crease to the mid-palmar crease and including both the thenar and hipothenar eminences. As seen more specifically in FIG. 28, the proximal palm receiving section (84) typically has a generally flat configuration substantially in register with the shank (66).

The lateral edges of the proximal palm abutment area (84) typically taper integrally towards an intermediate palm abutment area (88) for abutting against an intermediate section of an intended region (90) of the palm of an intended user, such as shown in FIG. 136. The palm intermediate region typically extends from the midpalmar crease to the proximal flexion crease including a distal transverse crease and encompassing the palmar aponeurosis.

While the proximal palm region (86) typically encompasses the carpus bones, the intermediate palmar area (90) typically encompasses the five metacarpal bones. As it is well known, the bodies of the metacarpals are slightly concave on their medial and lateral size where the dorsal inter-osseous muscles attached. Also, the basis of the metacarpals are ranged in a fan-shaped manner from the distal row of the carpal bones. In order to ergonomically adapt to the generally concave shape of the intermediate region of the palmar (90), the palm intermediate abutment area (88) typically defines a generally convex protrusion (92) as shown in FIG. 28 and 29.

Also, because of the generally downwardly slanted orientation of the peripheral surface ridge (82), the palm intermediate abutment area (88) defines lateral areas (92) for ergonomically abutting against the index and thumb of the intended user.

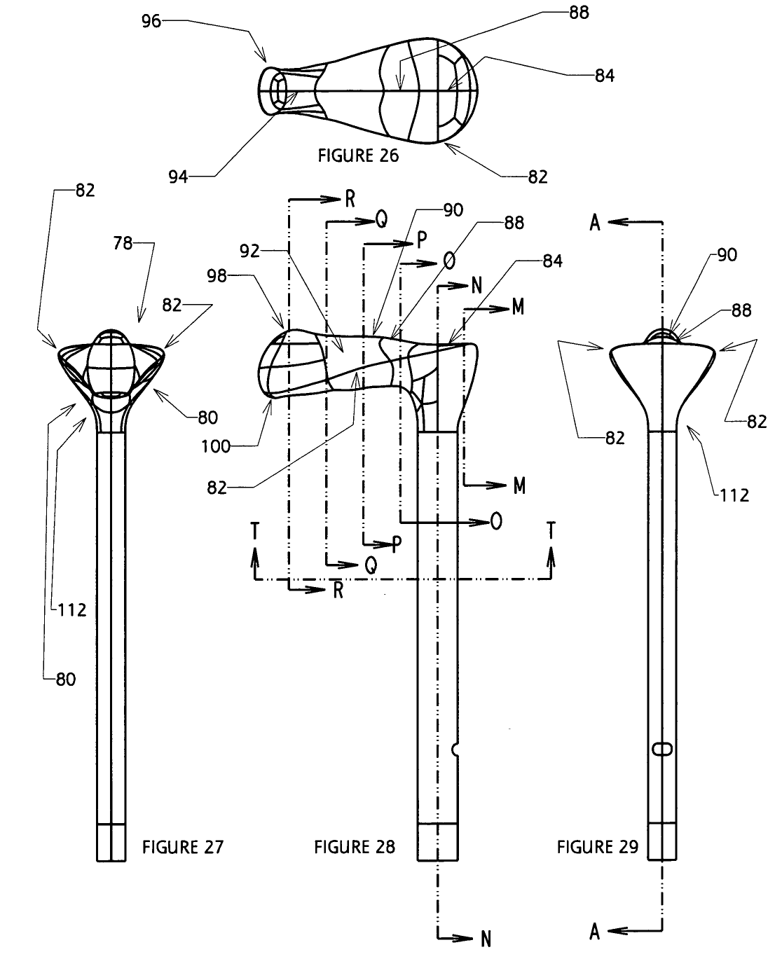

As shown more specifically in FIG. 26, the palm intermediate contacting area (88) extends integrally into a neck region (94) widening distally into a slip limiting area (96). The slip limiting area (96) also bulges so as to define a slip limiting protrusion (98) when seen in a side view such as FIG. 28. The auxiliary abutment surface (80) similarly defines an auxiliary slip limiting protrusion (100) generally in register with the main slip limiting protrusion (98).

In use, the grasping section (64) is grasped by the intended user unlike conventional grasping handles. Typically, the proximal palmar region (86) is abuttingly rested in a generally flat configuration against the proximal palmar abutment area (84) and ergonomically supported by the latter. Most of the weight imparted on the walking cane (10) is transmitted directly and generally colinearly from the proximal palmar abutment area (84) to the shank (66) and, in turn, to the remainder of the walking cane.

As illustrated in FIG. 4, the majority of the force (102) applied to the walking cane is transmitted through the latter so as to be transmitted generally colinearly with the center of gravity (58) lying in the sustentation polygon. Application of the force (102) in line with the center of gravity of the cane (58) prevents the creation of an undue bending moment typically associated with conventional walking canes.

As shown in FIG. 2, when a vertical force (102′) is applied to the grasping handle of conventional walking canes, the grasping handle being offset relative to the stem of the cane creates a bending torque proportional to the offsetting (104) and to the strength of the applied force (102′). The applied force (102′) hence causes the cane to deflect as shown in FIG. 2, decreasing overall structural stability of the cane and leading to unergonomical forces which must be unergonomically balanced by the intended user.

Hence, by having the handle face forwardly, such as shown in FIG. 4, and by having the majority of the applied force (102) extend vectorially generally colinearly with the center of gravity (58) of the cane (10) the latter is able to withstand greater forces without bending.

The cane is hence mote robust and dynamically stable. Furthermore, bending of the cane associated with unergonomical reaction forces are reduced. Consequently, the cane is less susceptible of generating muscle fatigue and stress on the anatomical components of the intended user.

During use, the intermediate region (90) of the palm of the intended user is ergonomically supported in its anatomical concave configuration by the convex protuberance (90). The index and thumb (106), (108) of the intended user are adapted to ergonomically rest on the lateral faces (92) of the thumb intermediate area (88) above the surface ridge (82). The slip limiting protuberances (98), (100) as well as the diverging configuration of the slip limiting regions (96) are adapted to prevent forward slippage of the hand of the intended user towards the handle distal end (74).

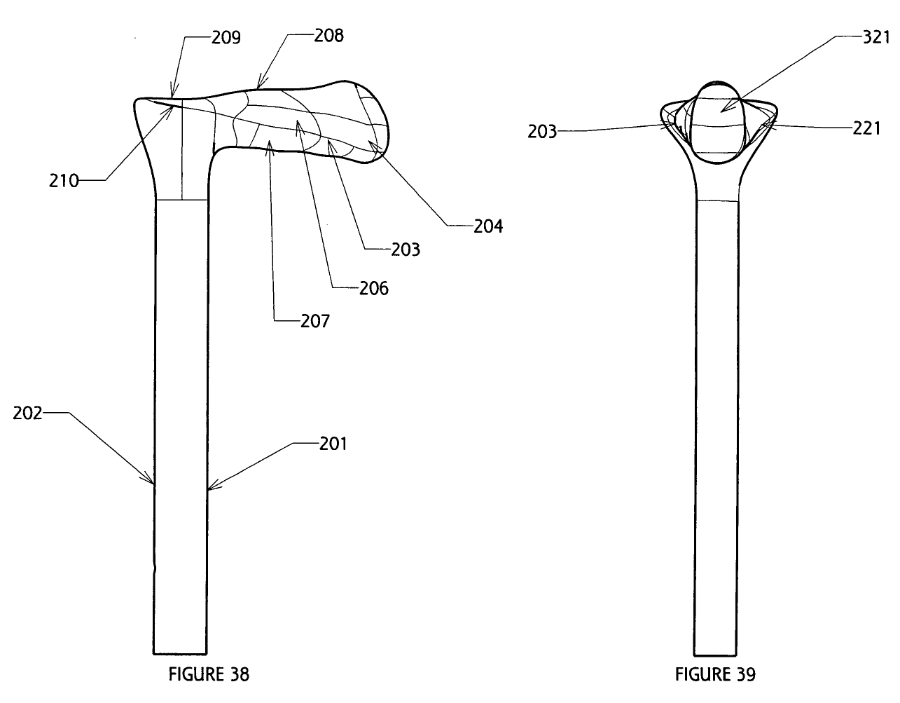

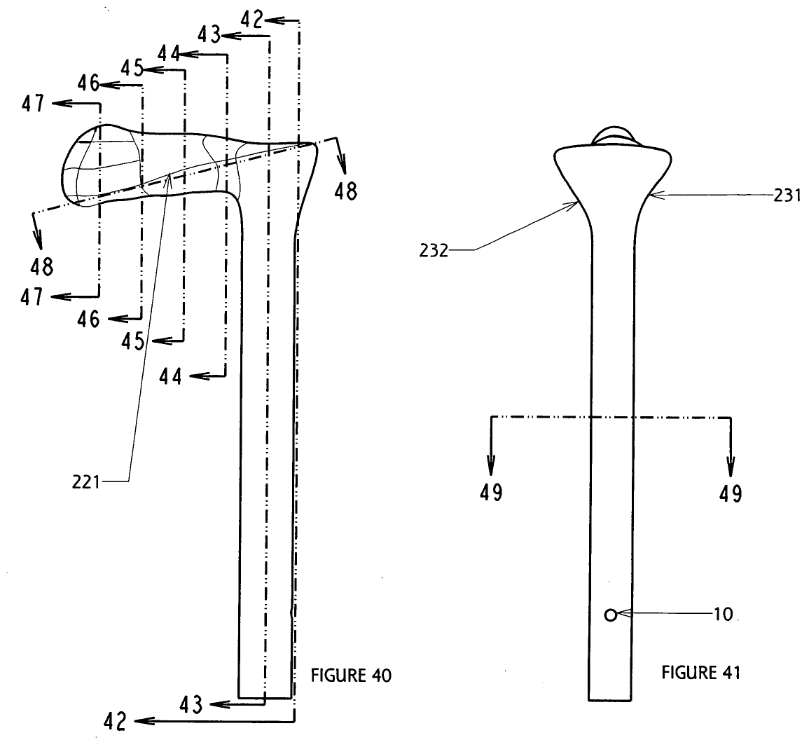

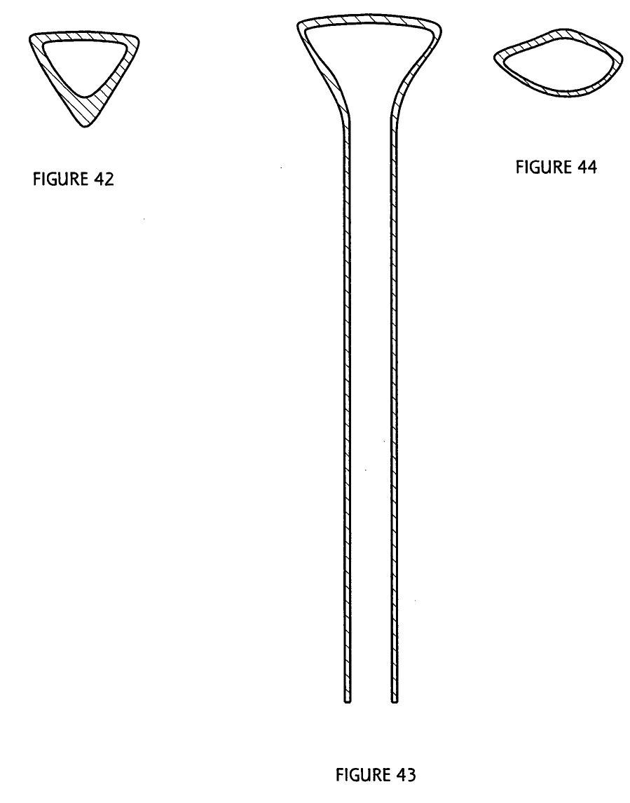

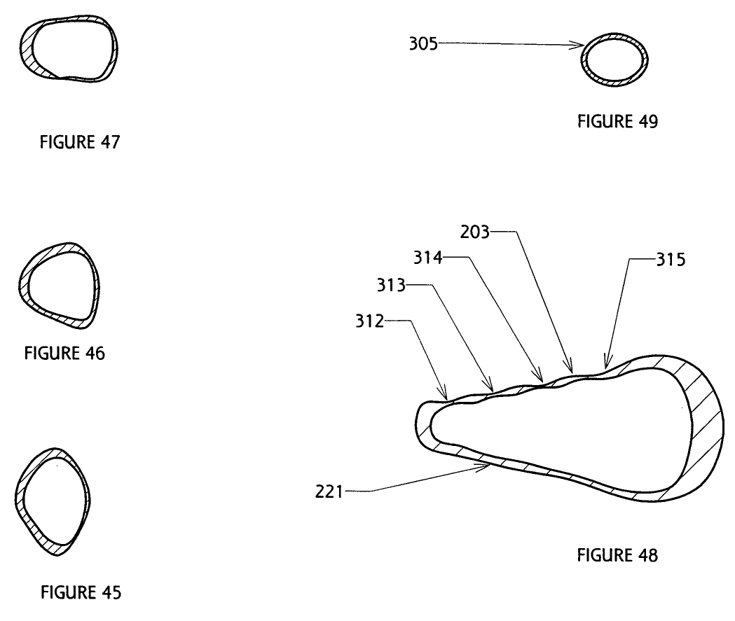

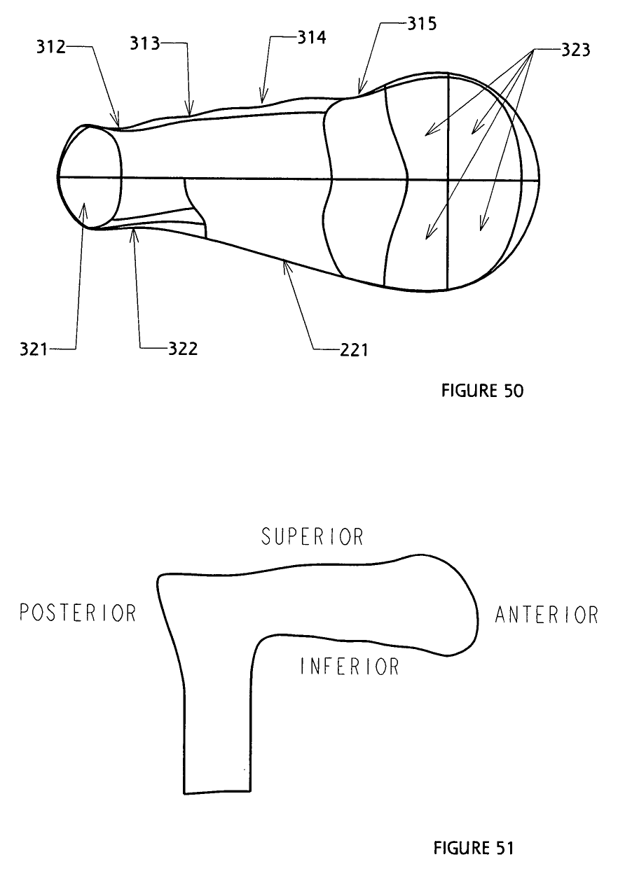

Referring to FIG. 38 to 51, there is shown a handle (20′) in accordance with an alternative embodiment of the invention. The handle component (20′) is substantially similar to handle component (20) shown in FIGS. 24 through 37 and, hence, similar reference numerals will be used to denote similar components. One of the main differences between the handles (20) and (20′) resides in that the handle (20′) is provided with finger receiving recesses (110) extending along a lateral side thereof for receiving the fingers of the intended user. Hence, the handle (20′) is not ambidexterous but rather designed specifically for either right or left handed users.

As illustrated more specifically in FIG. 31, the handle component (20) is preferably hollowed out both in the handle grasping section (64) and in the shank region (66). The hollow configuration of the handle component (20) allows the center of gravity 58 of the walking cane (10) tend to remain relative low. In order to maintain structural rigidity of the handle component (20) despite the hollowed out configuration of the latter, the transitional section (112) between the grasping section (64) and the shank section (66) is thickened. Also, the cross sectional configuration of the shank portion (66) is typically given a generally oval shape so as to optimize the longitudinal moment of inertia.

The hollowed out configuration of the shank portion (66) also facilitates insertion therein of some of the components of the handle-to-stem releasable attachment means (24). As shown in FIG. 5, the handle-to-stem releasable attachment means (24) typically includes a locking pin (116) and a pin biasing means (118) for biasing the locking pin (116) towards a locked configuration.

As shown in FIG. 31, the handle-to-stem releasable attachment means (24) further includes at least one shank locking aperture (121) extending through the shank peripheral wall (114). As shown in FIG. 21, the handle-to-stem releasable attachment means still further includes at least one and preferably a set of stem locking apertures (123) extending through the stem peripheral wall (66).

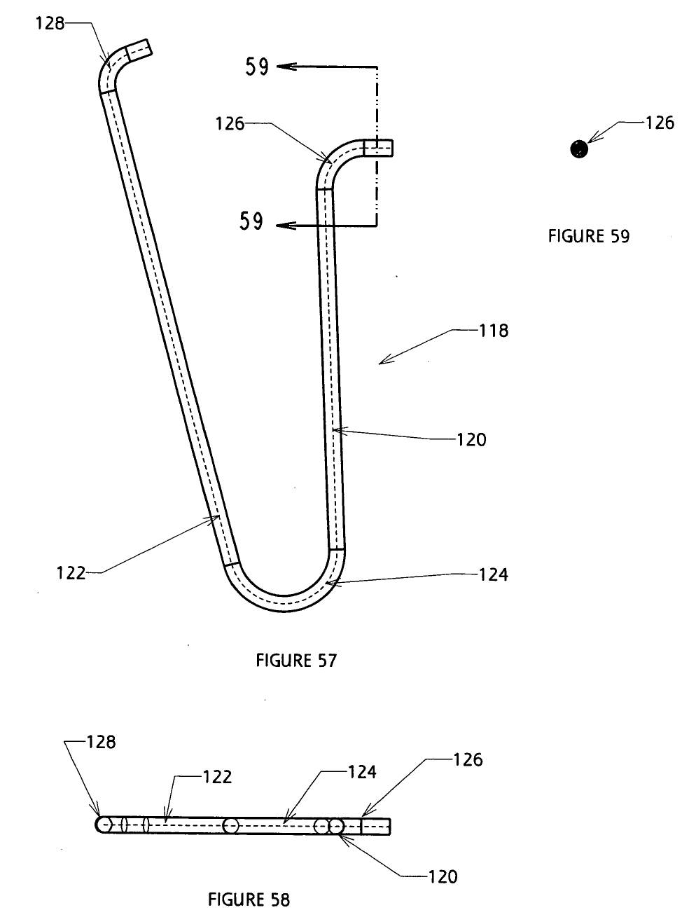

The biasing means (118) typically includes a biasing clip having a generally V-shaped configuration including a clip first leg (120) bending integrally into a clip second leg (122) about a clip leg merging section (124). The biasing clip (118) is typically made out of a generally resiliently deformable material allowing the clip first and second legs (120), (122) to bend towards each other upon a bending force being exerted thereon and to resiliently spring back towards their initial configuration, shown in FIG. 57 upon the force being released. The clip first leg (120) bends integrally into a pin-receiving segment (126) located generally opposite the clip-bending segment (124). The clip second leg (122) defines an abutment shoulder (128) located generally opposite the clip-bending segment (124).

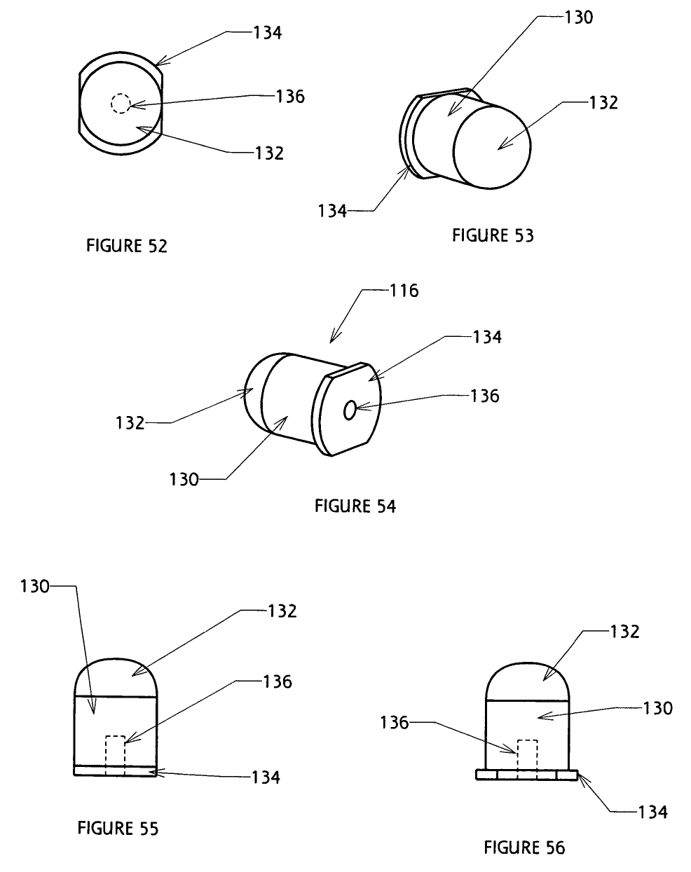

As shown in FIG. 52 through 56, the locking pin (116) defines a generally bullet-shaped pin stem (130) having a generally rounded apex (132). The locking pin (116) also includes an abutment rin (134) positioned generally opposite the apex (132). The locking pin (116) further includes a clip attachment channel (136) extending generally longitudinally therein. The clip attachment channel (136) is configured and sized so as to generally fittingly receive the pin attachment segment (126). The pin attachment segment (126) is configured and sized so as to be generally frictionally retained within the pin attachment channel (136) when mounted thereon.

As illustrated more specifically in FIG. 22, the biasing clip (118) is adapted to be inserted into the shank portion (66) with the abutment shoulder (128) resiliently abutting against an inner surface of the shank peripheral wall. The locking pin (116) mounted on the pin attachment segment (126) is adapted to extend through the shank aperture (120) and one of the shank apertures (123) for locking the shank section (66) in a predetermined axial telescopic engagement with the stem component (18). The handle-to-stem releasable attachment means (24) hence not only allows for releasable attachment of the handle component (20) to the stem component (18) but also allows for quick and easy and ergonomic length adjustment of the walking cane (10).

It should be understood that various modifications could be made to the handle-to-stem releasable attachment means without departing from the scope of the present invention. For example, although the stem apertures (123) are located generally on the proximal face of the stem component (18) so as to take advantage of the forces imparted on the stem component (18) which tend to force the locking pin (116) in locking engagement with the locking apertures. The stem apertures (123) could be located at other locations without departing from the scope of the present invention. Also, although a single shank-locking aperture (121) is illustrated in FIG. 31, the shank portion (66) could be provided with numerous shank locking apertures (121) so as to increase the range of length adjustment without departing from the scope of the present invention.

FIGS. 66 in an exploded perspective view, illustrates the construction of a clip component such as shown in FIG. 5. The clip component (26) includes a generally cylindrical collar (138), a tongue (140) and a linking arm (142) mechanically coupled therebetween. Typically the linking arm (142) is mechanically coupled to both the collar (138) and the tongue (140) respectively through first and second linking pins (144), (146).

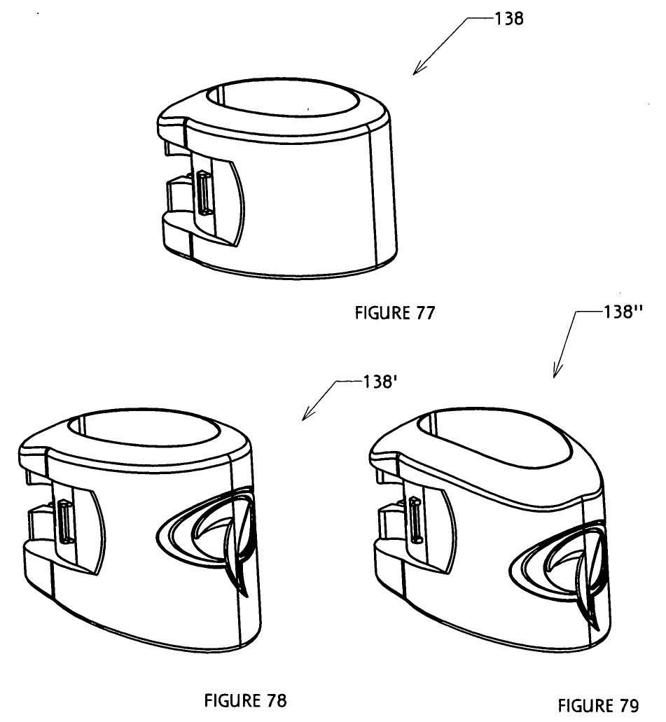

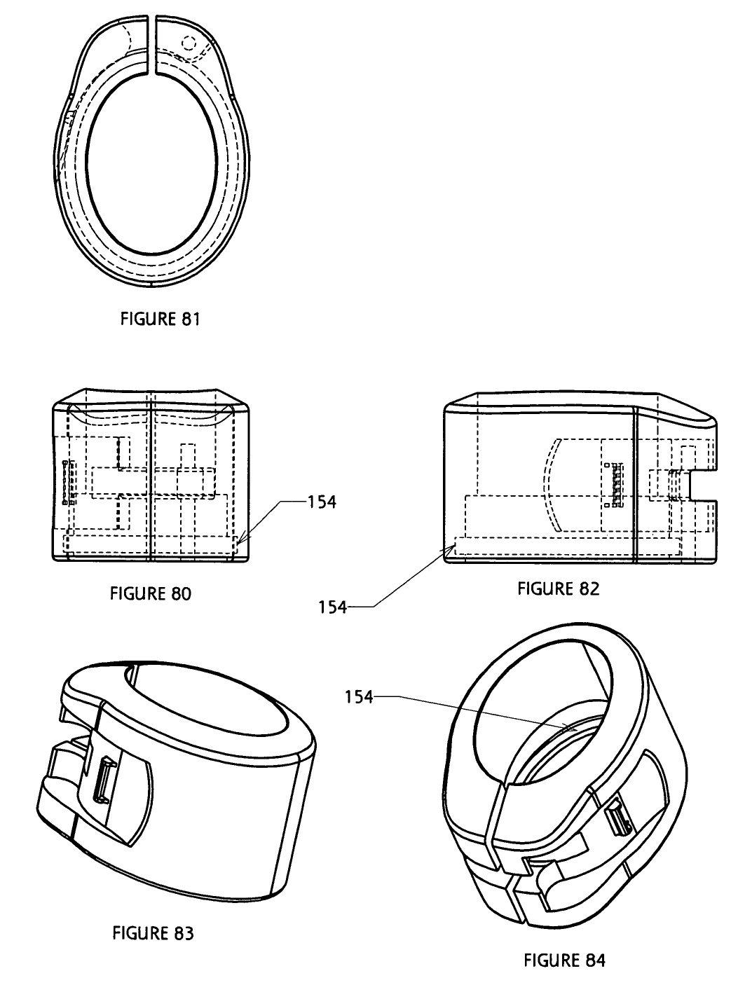

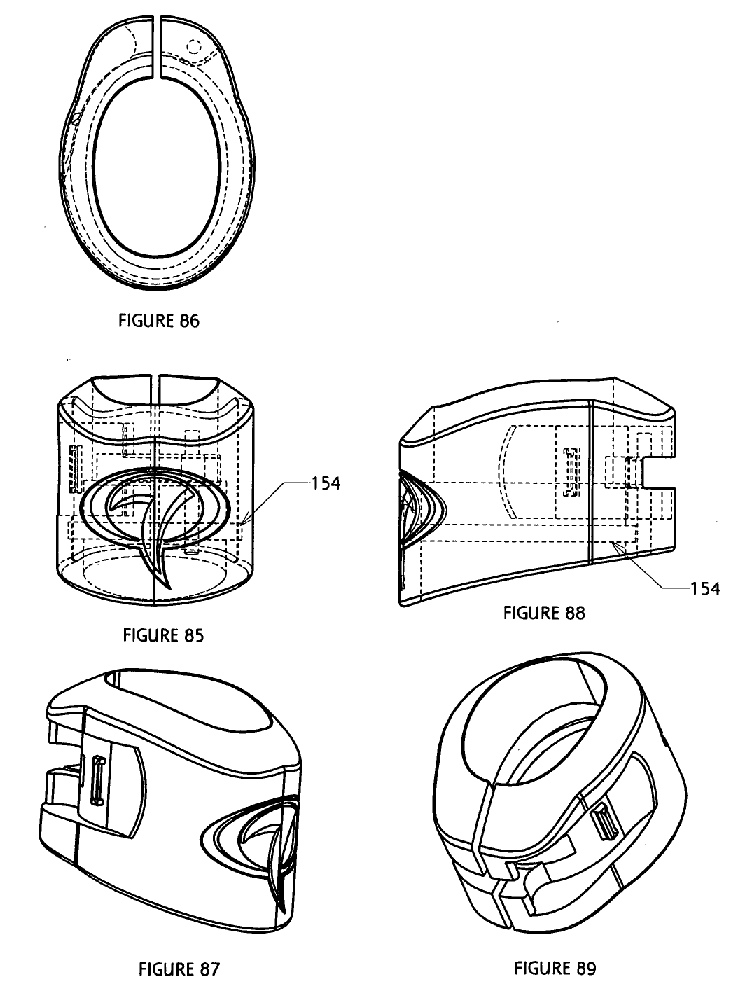

As shown respectively in FIGS. 77 through 79, three types of collar components (138), (138′) and (138″) may be used without departing from the scope of the present invention. The collars (138) through (138″) are generally similar to each other and, hence, similar reference numerals will be used to denote similar components. One of the main differences between the collar components (138) through (138″) resides in the aesthetical appearance of the external surface of the latter and, in particular their respective upper and lower peripheral flanges.

An optional type of collar component (250) is illustrated in FIG. 140. This fourth embodiment of the collar component allows for fixed attachment on the stem section (66). In this fixed configuration, the tongue component (140) is not present. To retain the collar component (250) in a closed position, a numerous number of linkages 252, preferably two, as shown in the preferred embodiment, are inserted in the groove (256) and remained in their position using the pins (254).

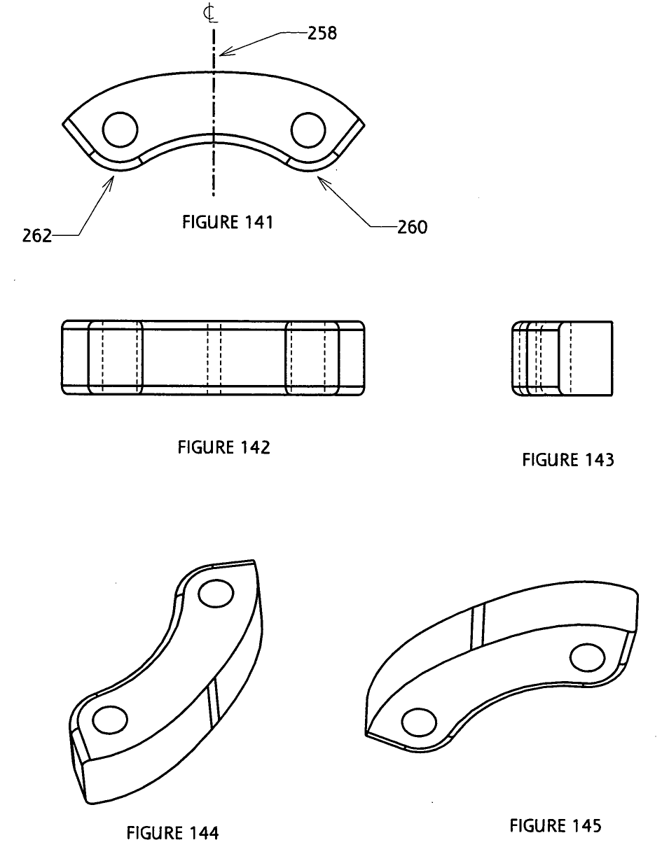

As shown in FIG. 141, the linkage (252) is has two rounded shapes (260) and (262) at both ends. Those two rounded shapes follow the shape of the grooves (256) on the collar component 250.

As illustrated more specifically in FIG. 66, each collar component (138) defines an interrupted collar peripheral wall (148) having a generally cylindrical collar internal surface (150) interrupted by a longitudinally extending collar slot (152). The collar inner surface (150) is configured and sized so as to substantially fittingly receive the outer surface of the shank section (66) of the handle component (20).

Preferably, the collar inner surface (150) has a lip receiving recess (154) formed therein for substantially fittingly receiving a corresponding anchoring lip (156) extending circumferentially from the outer surface of the shank section (66). The positioning of the lip receiving recess (154) varies depending on the embodiment of the collar component (138). However, the lip receiving recess (154) of all embodiments is typically configured and sized so as to substantially fittingly receive the lip (156) when the collar is in its closed configuration, illustrated in FIGS. 60 and 61.

As illustrated more specifically in FIGS. 64 and 66, the external surface of the collar peripheral wall (148) is typically provided with a generally elongated linkage arm receiving recess (158) merging integrally with a corresponding tongue receiving recess (160). The tongue receiving recess (158) is configured and sized so as to pivotally receive the linkage arm (142) and allow the latter to pivot about the first pivot pin (144).

The arm receiving recess (158) is typically provided with at least one and preferably two first pin receiving apertures (162) formed therein for receiving the first linking pin (144). Similarly, the linkage arm (142) is provided with a linkage arm first pin receiving aperture (164) extending therethrough for receiving the first linkage pin (144).

As illustrated more specifically in FIG. 70, the linkage arm (142) typically has a generally crescent-shaped configuration when seen in a top view. The linkage arm (142) defines a pair of distal ends (166), (168) both having a generally rounded contour. The distal end (166) is configured and sized so as to be mountable generally adjacent the collar component (138) while the distal end (168) is configured and sized so as to be mountable generally adjacent the tongue component (140).

The linkage arm (142) is further provided with a second pin receiving aperture (169) extending therethrough generally opposite the linkage arm first pin receiving aperture (164).

The tongue receiving recess (160) is configured and sized for substantially fittingly receiving the tongue component (140) and allowing pivotal movement thereof between a locked configuration, shown in FIGS. 60 and 61 and an unlocked configuration, shown in FIGS. 64 through 66.

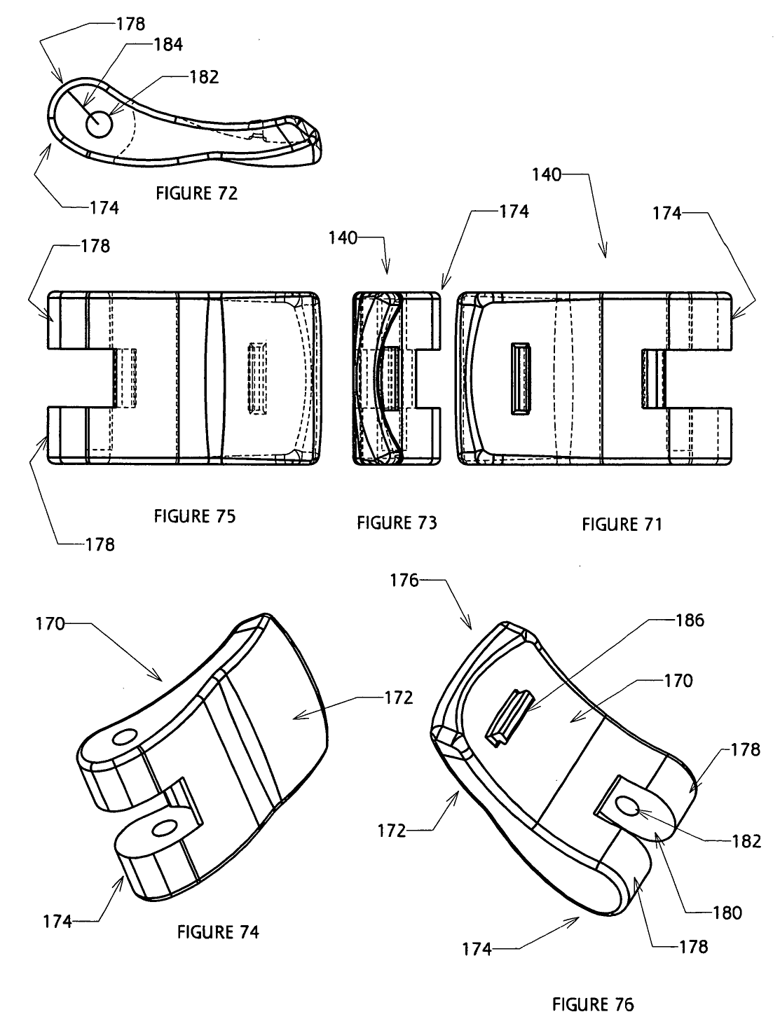

Referring now more specifically to FIGS. 71 through 76, there is shown in greater details the configuration of the tongue component (140). The tongue component (140) defines a tongue outer surface (172) and an opposed tongue inner surface (170). Typically, the tongue component (140) has a generally arcuate configuration and further defines a tongue proximal end (174) and an opposed tongue distal end (176).

The tongue proximal end (174) typically defines a generally forked configuration having a pair of tongue prongs (178) with a generally convex and arcuate proximal contour. The prongs (178) define a prong spacing (180) therebetween for receiving the linkage arm distal end (168). The prongs (178) are preferably provided with prong apertures (182) extending transversally thereacross for receiving the second mounting pin (146) so as to allow the latter to provide a pivotal connection between the tongue component (140) and the linkage arm (142).

The rounded contour of the prong components (178) is configured and sized so as to interact with corresponding tongue abutment surfaces (184) formed in the tongue receiving recess (160). As illustrated more specifically in FIG. 72, the prong apertures (182) are generally offset relative to a theoretical center line (184) for generating the radius of curvature of the outer surface of the abutment surface of the prongs (178). Accordingly, the proximal outer surface of the prong components (178) is adapted to act as a cam for biasingly and frictionally locking the tongue (140) in the tongue closed configuration.

The tongue inner surface (170) is preferably further provided with a locking lip (186) extending generally perpendicularly therefrom. The tongue locking lip (186) is adapted to cooperate with a collar locking lip (188) extending from the inner surface of the tongue recess (160) for providing a complimentary locking mechanism adapted to lock the tongue component (140) in its locked configuration.

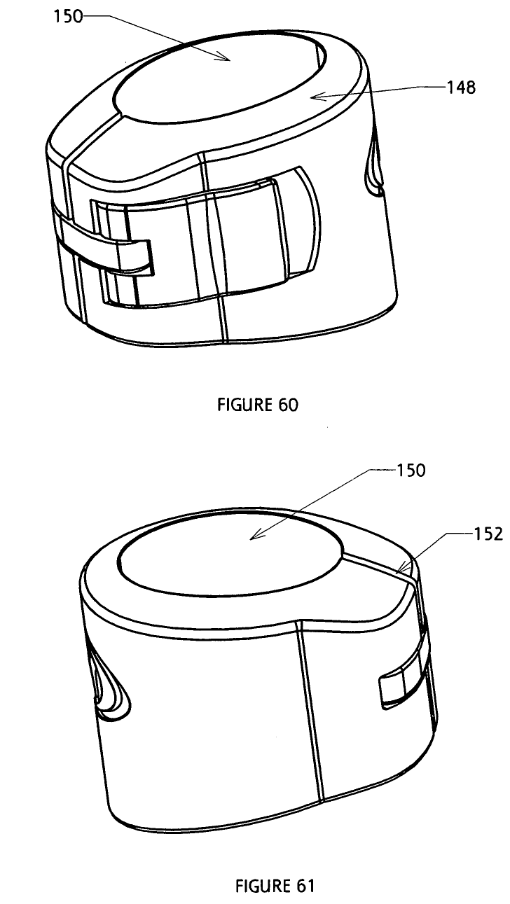

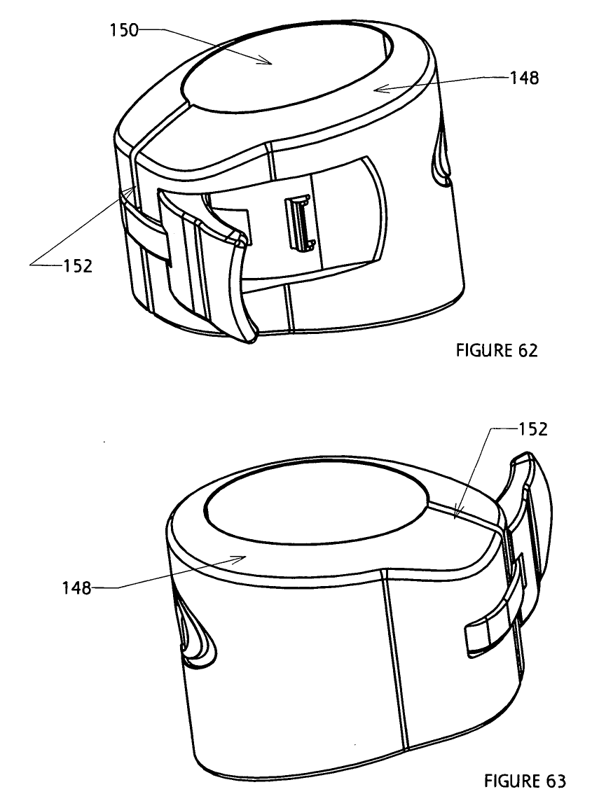

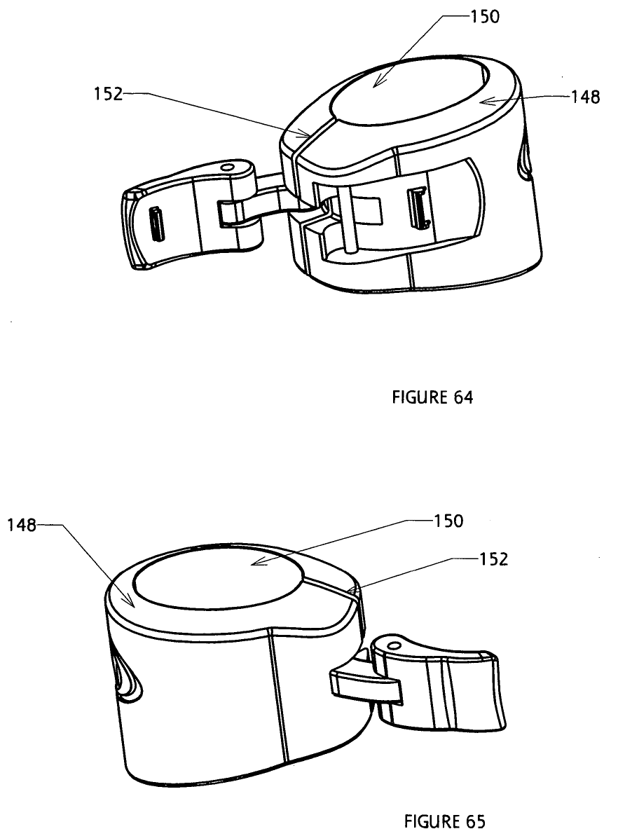

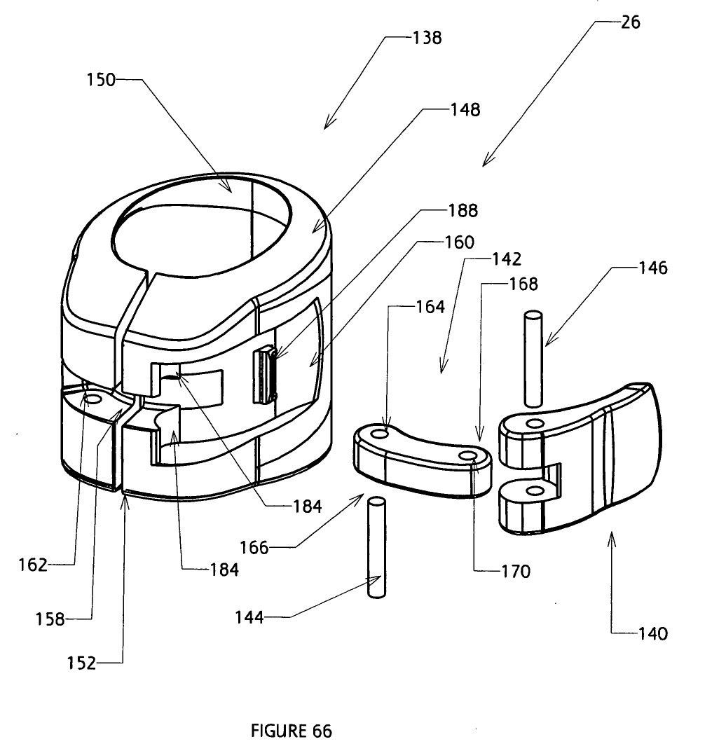

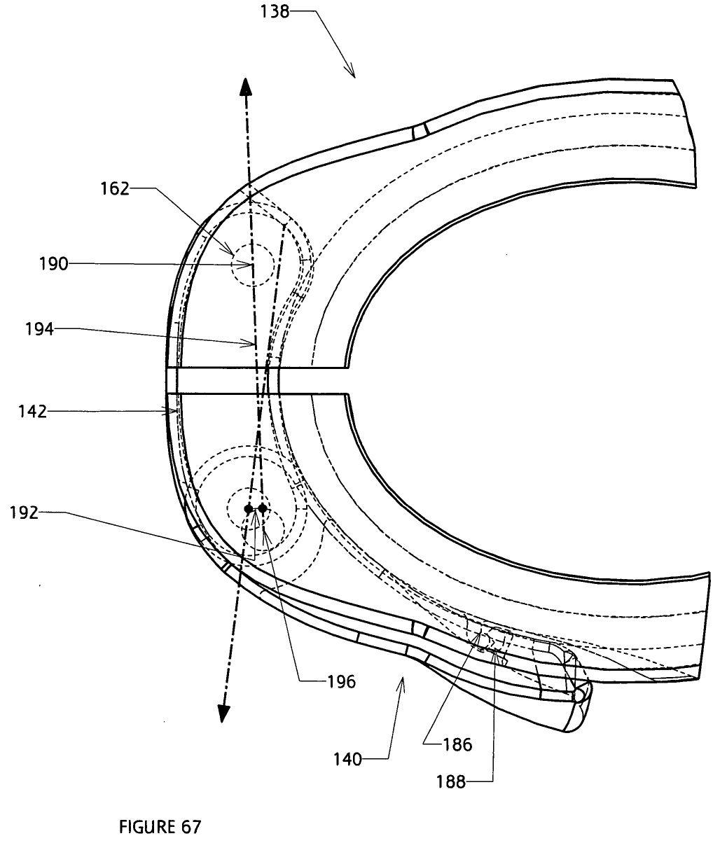

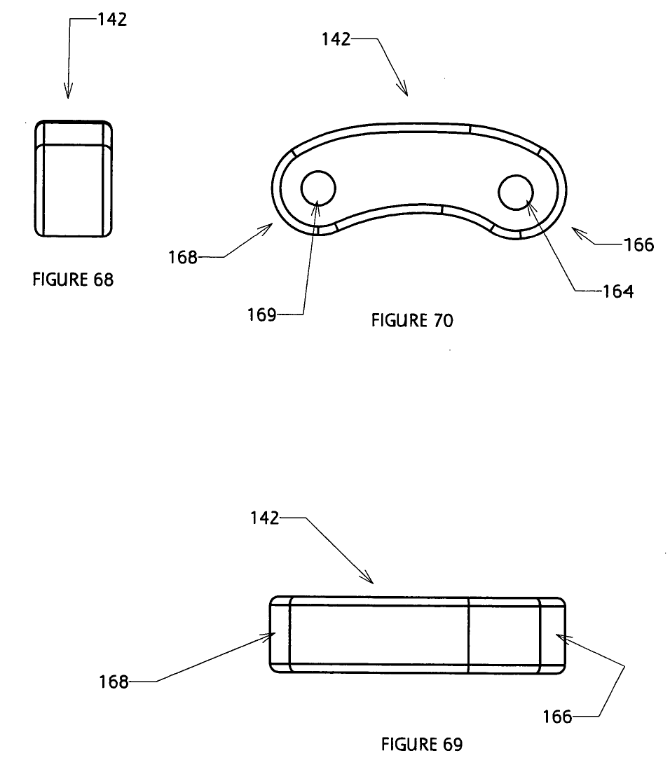

Furthermore, as illustrated more specifically in FIG. 67, the linkage arm recess (158), the tongue recess (160) and the first pin receiving aperture (162) are configured, sized and positioned so that the rotational axis (190) is offset by a rotational axis offsetting distance (192) perpendicular to an intercepting axis (194) intercepting both the rotational axis (190) and tongue rotational axis (196) relative to the latter. Hence, clamping of the tongue component (140) in the locked configuration creates an inherent biasing force for biasing the locking tongue (140) so that the latter remains in the locked configuration.

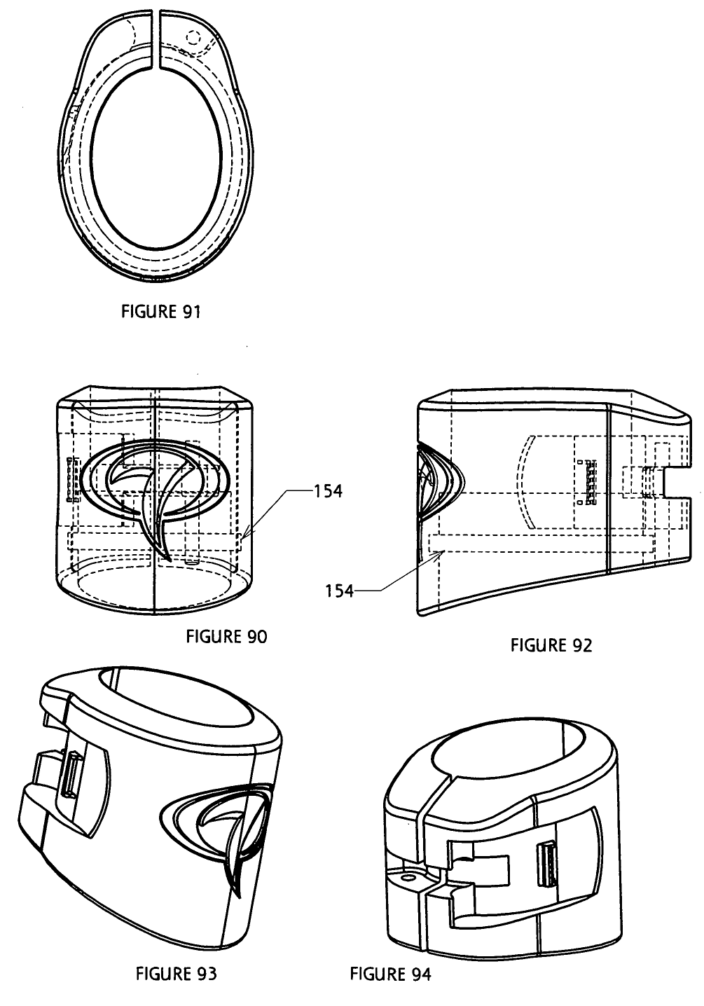

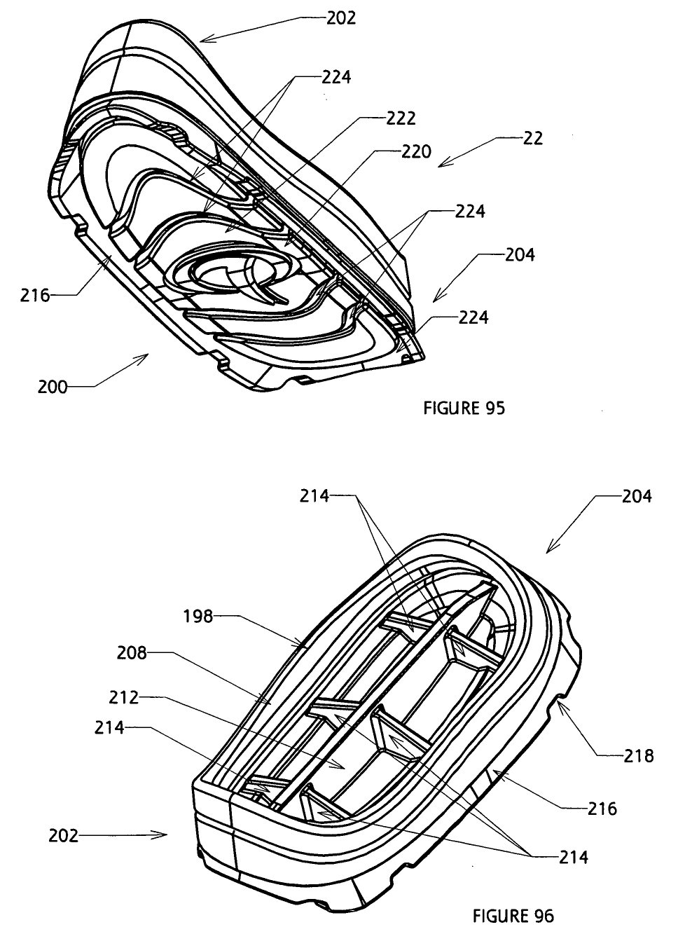

Referring to FIG. 95, there is shown a sole component (22) in accordance with an embodiment of the present invention. The sole component defines a sole inner surface (198) and an opposed sole outer surface (200). The sole component (22) also defines a sole first longitudinal end (202) and an opposed sole second longitudinal end (204). The sole component includes a sole base wall (206) extending generally thereacross. The sole component also includes a sole peripheral flange (208) extending generally upwardly from the lateral peripheral edge of the sole base wall (206).

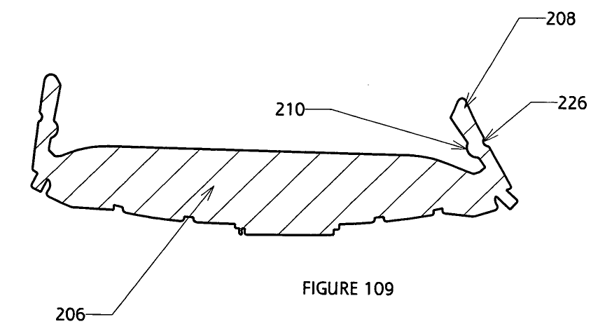

As illustrated more specifically in FIG. 109, the sole flange (208) is preferably provided with a sole attachment lip (210) extending inwardly from an inner surface thereof. The sole attachment lip (210) is configured and sized so as to be releasably and generally fittingly insertable into the stem groove (62) shown in greater details in FIG. 12. The sole component (22) is preferably made out of a generally resiliently deformable material so that the sole attachment lip (110) may be resiliently and releasably inserted into the stem groove (62) to resiliently and releasably attach the sole component (22) to the stem component (66).

Referring now more specifically to FIG. 96, there is shown that the sole component (22) is provided with a longitudinal reinforcement rib (212) extending longitudinally thereacross in a set of transversal reinforcement ribs (214) extending transversally thereacross for increasing the overall robustness of the sole component (22).

As shown in FIG. 95, the sole outer surface (200) typically includes a generally peripherally disposed peripheral lip (216) extending generally integrally and flaring generally outwardly from the lower peripheral edge of the sole flange (208).

The peripheral lip (216) is typically provided with lip indentations (218) formed therein for facilitating deformation thereof so as to provide a shock absorbing contact with the ground surface.

The outer surface of the sole base wall (206) is preferably provided with a ground engaging strip (220) positioned generally inwardly and recessed generally inwardly relative to the peripheral lip (216). The ground engaging strip (220) typically has a generally oval configuration with turned up end edged adjacent the sole first and second longitudinal ends (202) so as to form a generally convex surface when seen from the side. The ground engaging strip (220) merges integrally and inwardly into a generally concave central section (222).

Typically, a stabilizing lip (224) extends outwardly from the peripheral lip (216) adjacent the sole second longitudinal end (204). The longitudinally centered mid portion of the peripheral lip (216) and strip (220) combined with the section (224) are adapted to from a generally flat abutment surface for supporting the walking cane (10) in a generally upright position.

The strip (220) and the central region (222) are both preferably provided with anchoring grooves (224) formed therein for receiving anchoring sections part of the friction increasing component (28) as will be hereinafter disclosed in greater details. Also, as illustrated in FIG. 109, the sole flange (208) is provided with a flange anchoring recess (226) formed on the inner surface thereof for facilitating anchoring of the slip reducing component (208).

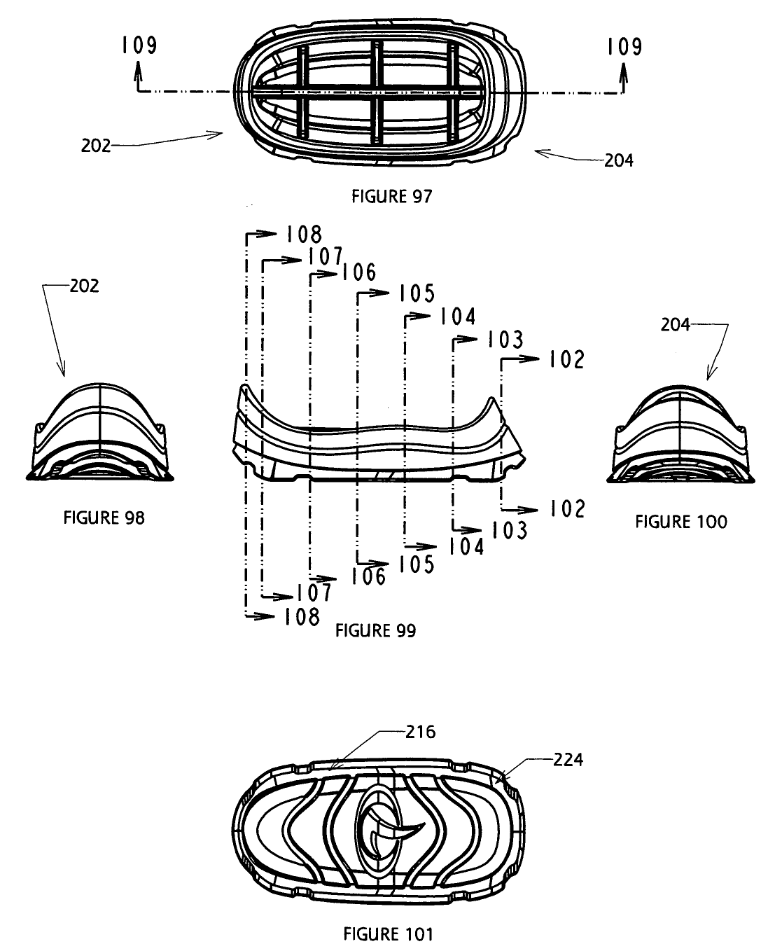

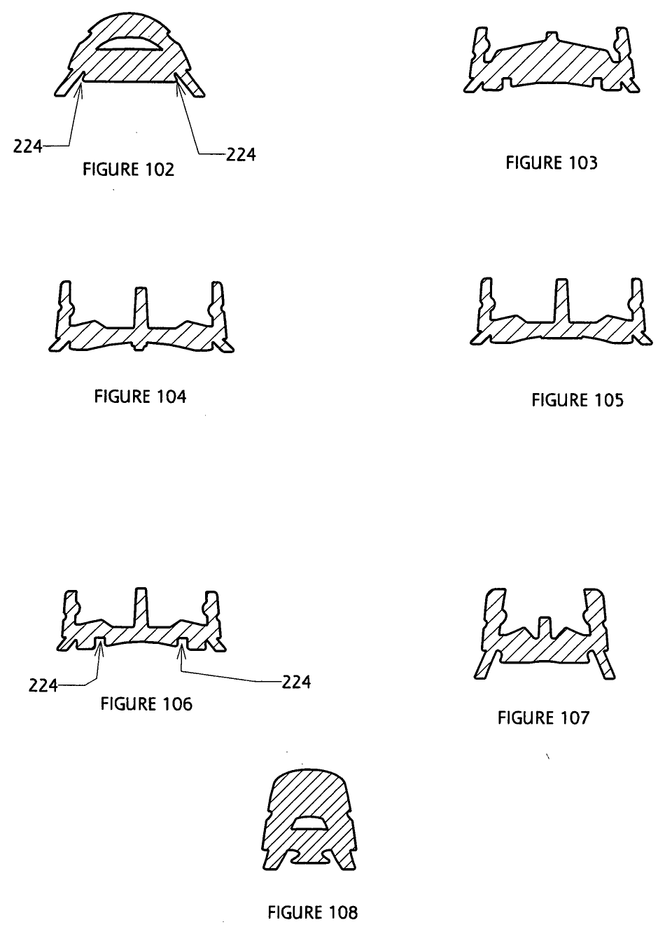

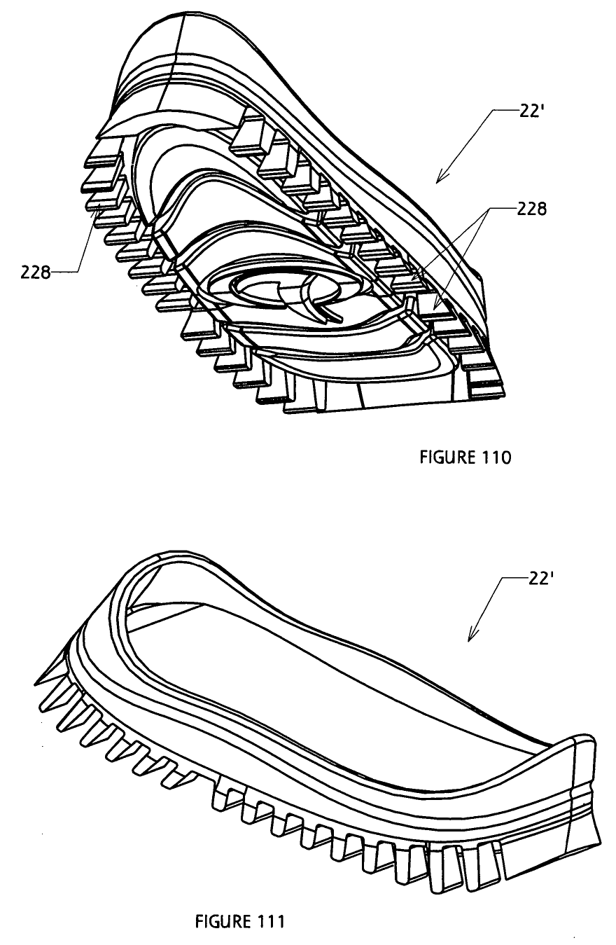

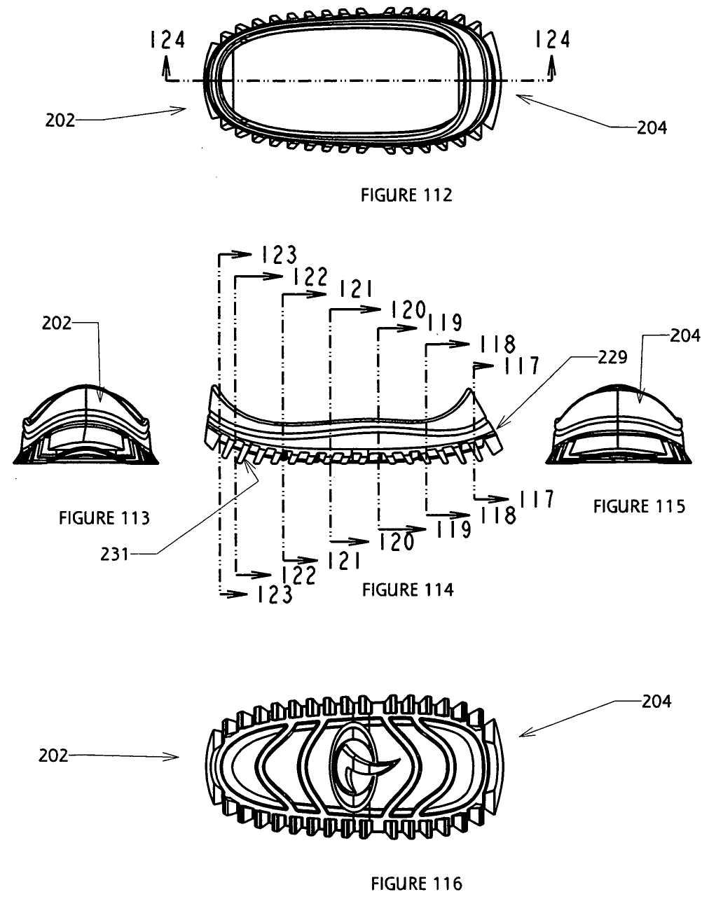

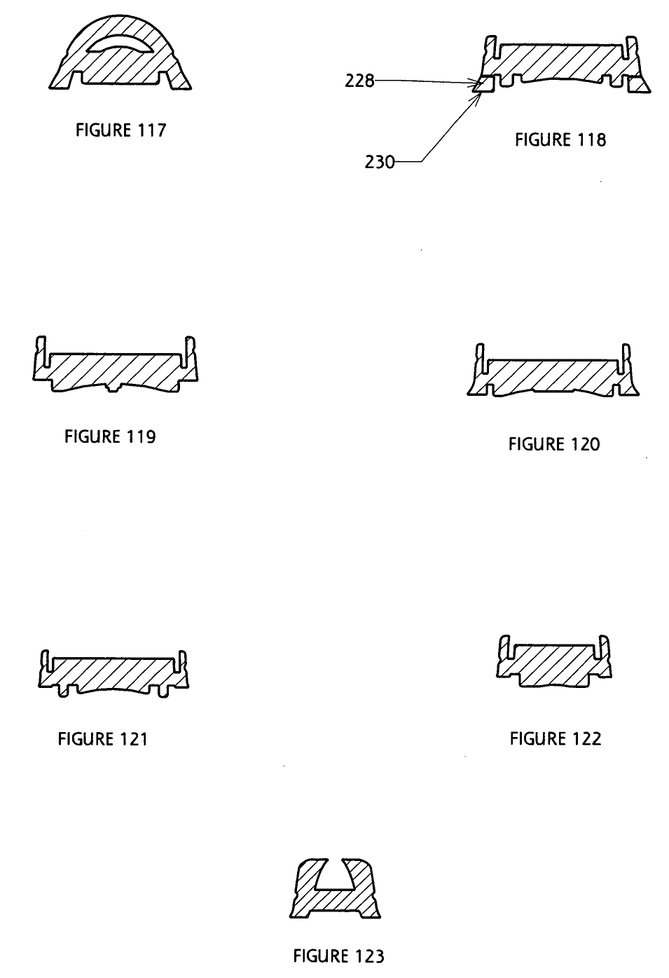

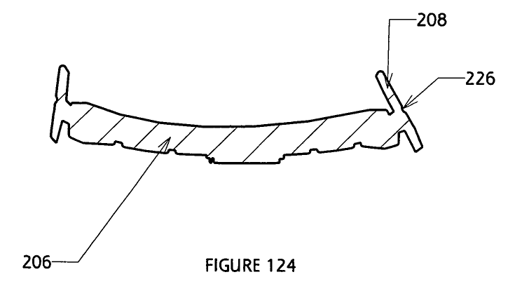

Referring now more specifically to FIGS. 110 through 124, there is shown a sole component (22′) in accordance with a second embodiment of the present invention. The sole component (22′) is generally similar to the sole component (22) shown in FIGS. 95 through 109 and, hence, similar reference numerals will be used to denote similar components. One of the main differences between the sole components (22) and (22′) resides in that the sole component (22′) is provided with abutment prongs (228) instead of the peripheral lip (216).

As shown more specifically in some of the cross sectional FIGS. such as FIGS. 118 and 120, the prongs (228) typically have a generally outwardly flaring configuration with a generally flat prong bottom surface (230). The outwardly flaring configuration combined with the flat prong abutment surface (230) increases stability of the sole component (22′). Typically, the sole component (22′) is provided with the same features as the sole component (22) including the longitudinal and transversal reinforcement ribs (212), (214), the locking protrusion and recess (210) and (226) although the latter are not shown in the drawings.

As shown in FIG. 114, the angle of the rear abutment prongs (229) and the forward prongs (231) are not in the same direction although both point downwardly. The rear abutment prongs (229) grow rearward and the front abutment prongs (231) grow forward. Although the rear and forward prongs point in different directions in this preferred embodiment FIG. 114, any orientation of those prongs may be used without departing from the scope of the present invention.

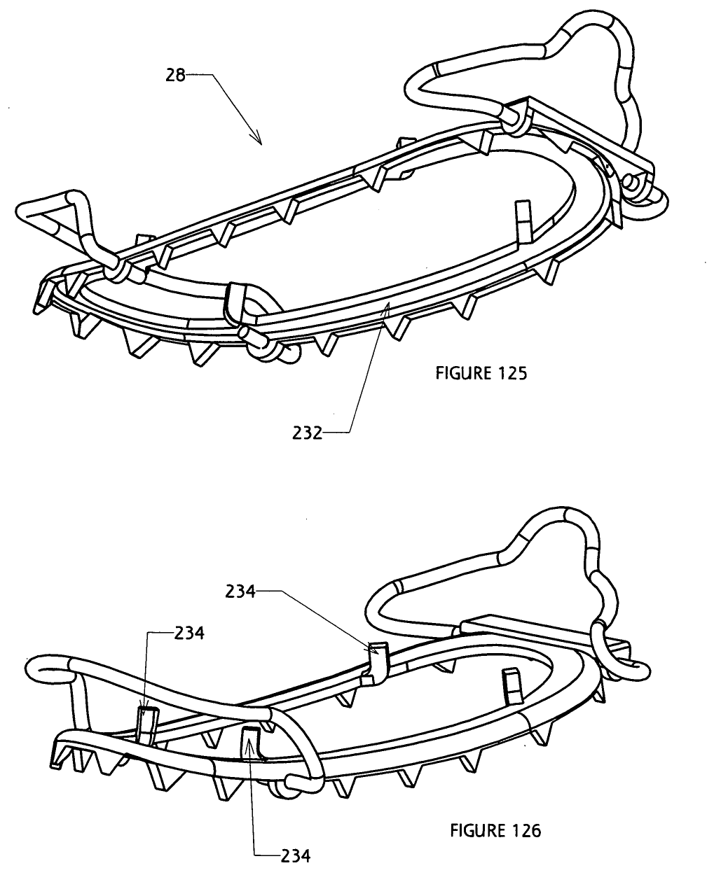

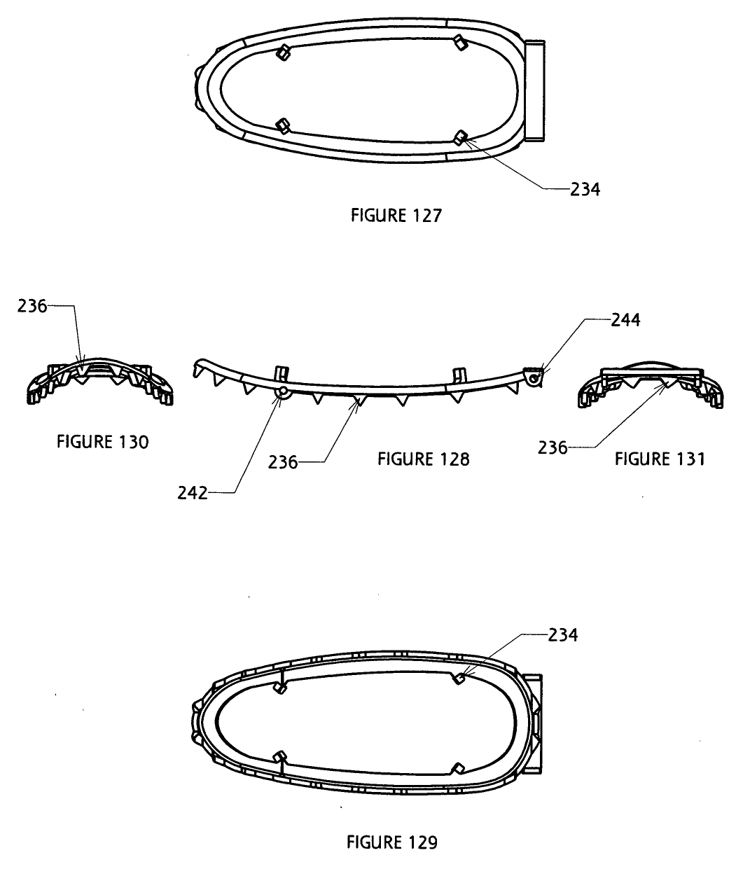

Referring now more specifically to FIGS. 125 through 133, there is shown an anti slip or friction enhancing component (28) optionally part of the invention. The component (28) includes a stabilizing annular frame (232) configured and sized so as to abuttingly contact the strip (220). Anchoring tabs (234) extend generally inwardly and upwardly from the annular frame (232). The anchoring tabs (234) are configured, sized and positioned so as to be insertable into the anchoring grooves (224).

As shown more specifically in FIG. 128, the frame (232) has a generally convex configuration so as to conform to the generally convex configuration of the strip (220). A set of ice gripping spikes (236) extend downwardly from the outer peripheral edge of the frame (232) and are configured and sized so as to provide a generally convex contacting surface similar to that of the strip (220).

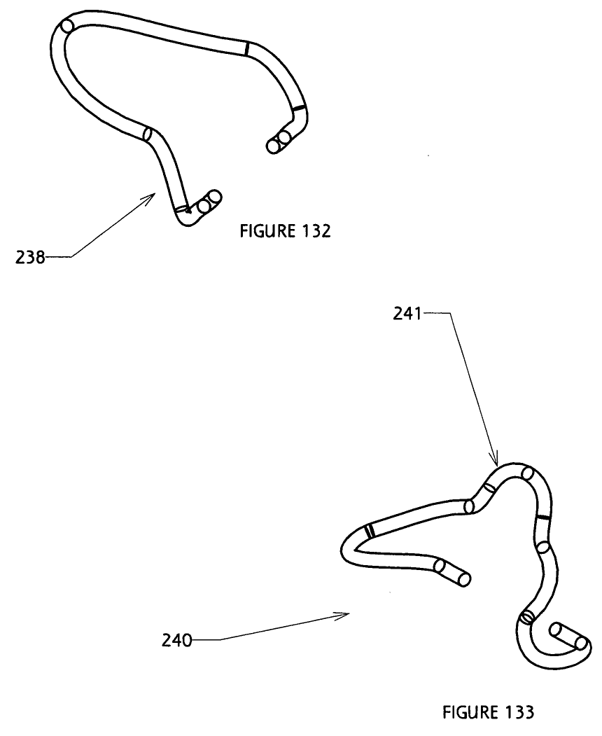

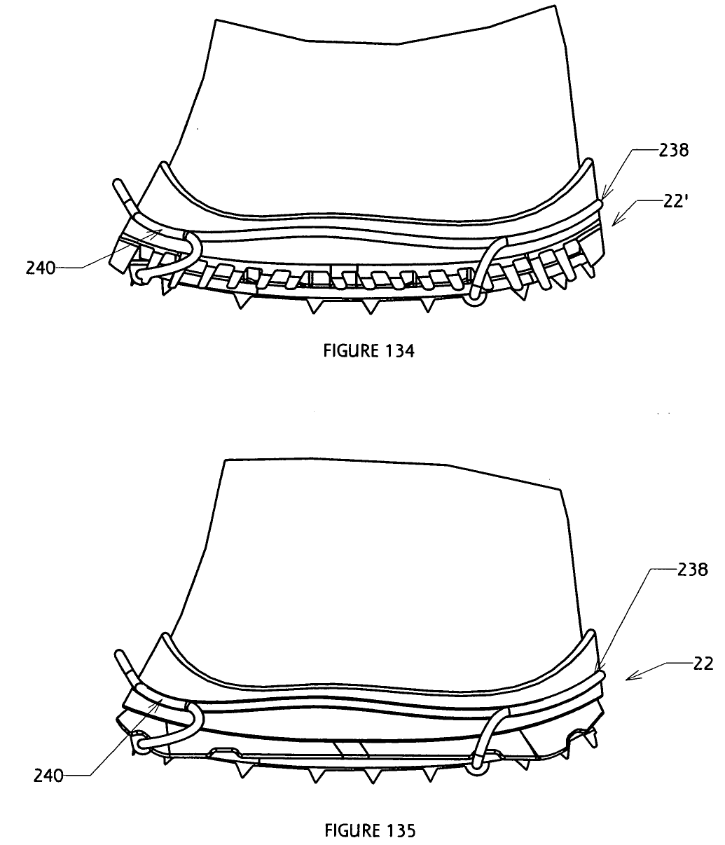

A front and a rear anchoring clips (238), (240) shown respectively in FIGS. 132 and 133 are adapted to be mounted respectively in mounting eyelets (242), (244) attached to the frame (232). The mounting clips (238), (240) are preferably provided with biasing means (not shown) such as conventional spring components for biasing the mounting clips (238), (240) in locking contact with the locking grooves (62) of the sole components (22), (22′) such as shown in FIGS. 134 and 135.

The rear mounting clip (240) has a foot releasing lever to open it up to release the sole component from its locked configuration. This foot lever (241) is to permit people with mobility problems not to bend or lift the cane and still be able to reach for the lever with their foot. This foot lever (241) can be integrally made or attached to the rear-mounting clip (240) without departing from the scope of the present invention.

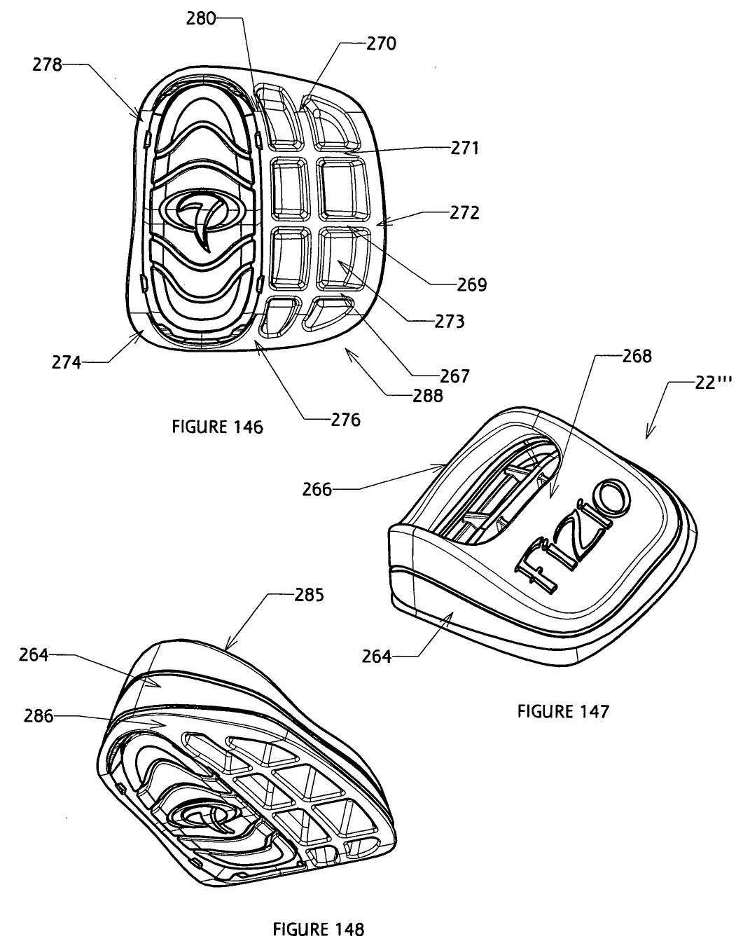

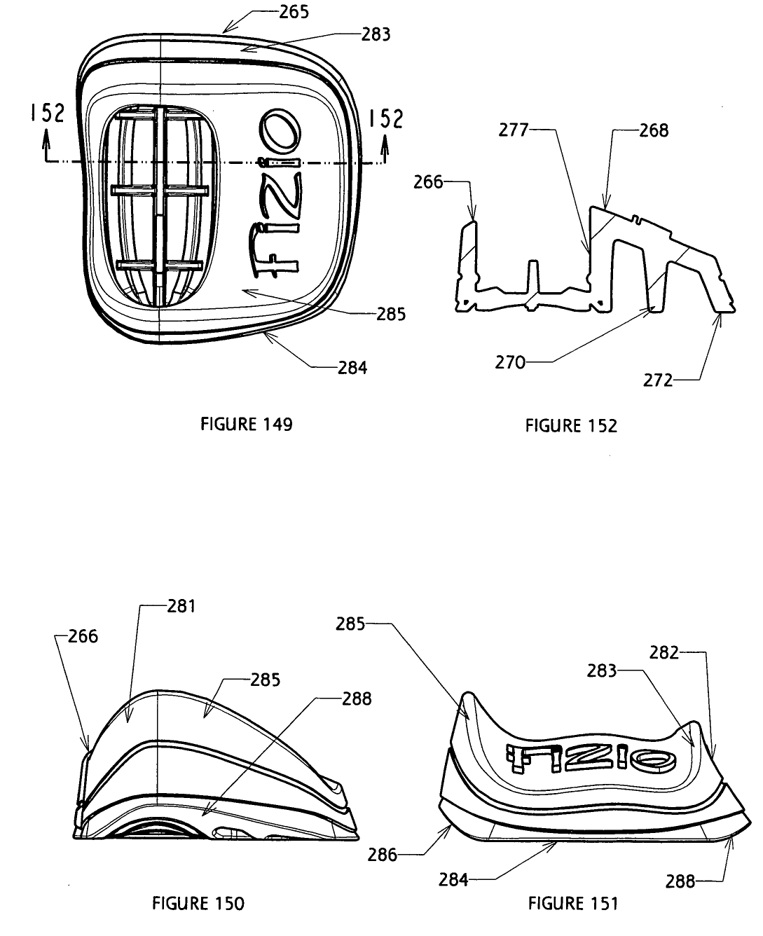

Referring now more specifically to FIGS. 146 through 152, there is shown a sole component (22″) in accordance with a third embodiment of the present invention. Shown on FIGS. 146 through 152 is a left configuration of third sole embodiment of the present invention. The sole component (22″) is generally similar to the sole component (22) shown in FIGS. 95 through 109. One of the main differences between the sole components (22) and (22′) and (22″) resides in that the sole component (22″) is provided with lateral ridges (283) and (285) providing more rigidity and strength instead of the peripheral contoured surface (281). The purpose of this third embodiment is to provide lateral stability when user applies force laterally from handle. Seen from FIG. 152, ridge (268) is higher than ridge (266) to provide more lateral rigidity when force is applied on surface (277). The rear portion of this third embodiment item (265) extends gradually laterally from the longitudinal middle plane inclined forwardly at a minimal angle approximately 5 degree towards the front. The front surface (264) extends gradually laterally from the longitudinal middle plane inclined towards the rear at a minimal angle approximately 5 degree.

Surface (284) is flat providing lateral and longitudinal stability to the user. It extends laterally to reach for support the ground to increase stability and resistance. Surface (264) is composed if different ridges (267), (269), (271), and (270) providing strength and solidity. A series of pockets generally similar to (273) are also present to reduce weight. Longitudinal ridges (270) and (272) will provide longitudinal support.

Outward ridges (274), (276), (278), (280) are thickened compared to the first embodiment of the sole component to cancel out the rocker motion. The resulting motion will be following rounded surface (288), transitioning to flat surface (284) and finishing off on surface (286) at the end of the gait cycle.

Surface (286) and (288) are rounded to provide fluidity in walking during the transition phases of the gait pattern.

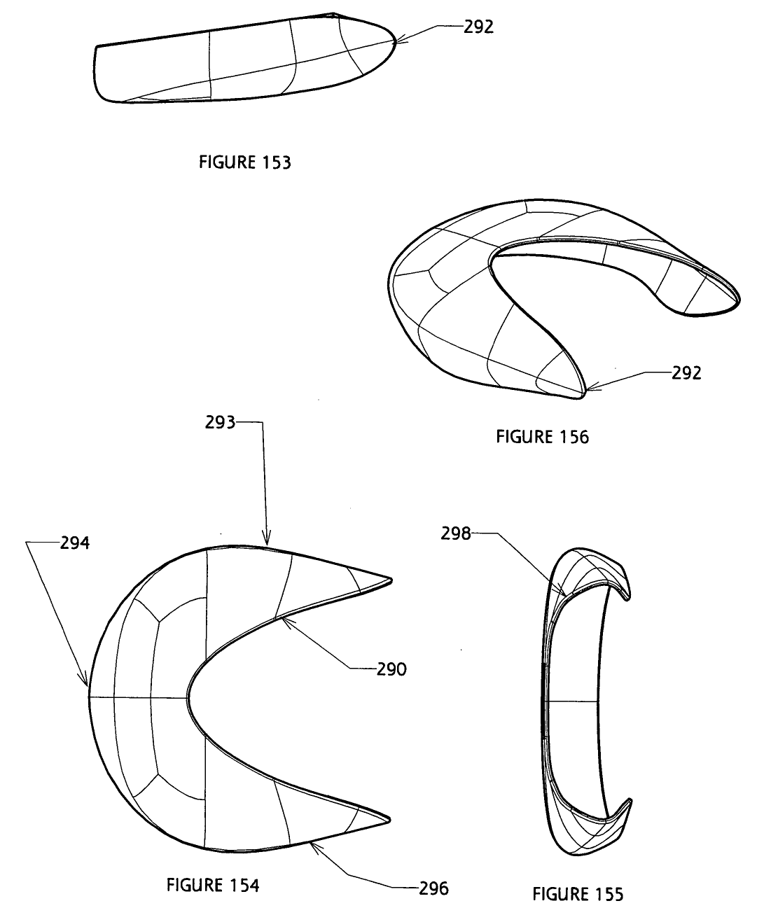

Referring now more specifically to FIGS. 153 through 156, there is shown an anti-slip component (25) in accordance with an embodiment of the present invention. The anti-slip component extends from the real portion (294) contouring the handle part following curved surfaces (293) and (296) to reach generally curved and downward surfaces (292). Contour (290) limits the amount of surfaces covered from the handle component. This anti-slip therefore protects the finish of the handle underneath the surfaces (293), (294) and (296). Surface (298) defines the thickness of the anti-slip component therefore defining the level of protection for the handle surface finish. Also, this anti-slip component is made of anti-slip resilient material to provide an anti-slippage effect from the hand to the handle. It should be understood that other configurations of the anti-slip component (25), bigger or smaller, covering different section from the handle component surface finish could be used without departing from the scope of the present invention.

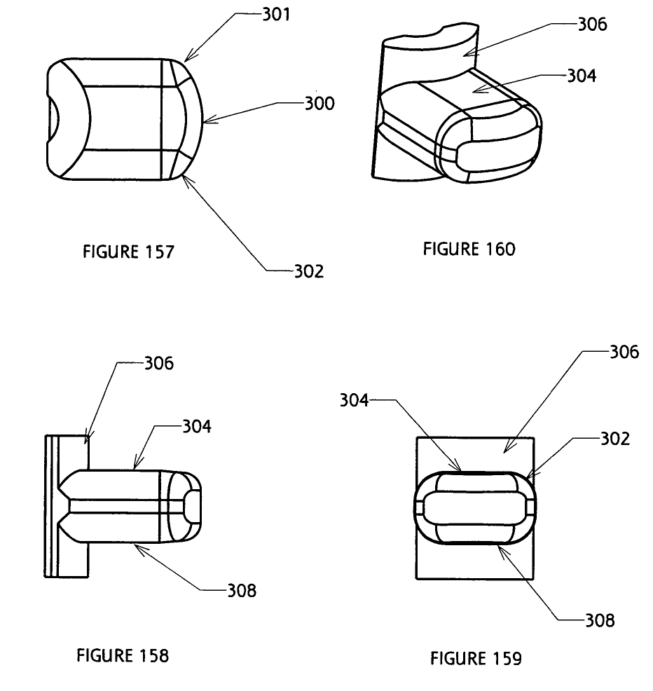

Referring now more specifically to FIGS. 157 through 160, there is shown a locking pin component (116′) in accordance with a second embodiment of the present invention. The locking pin component (116′) is generally similar to the locking pin component (116) shown in FIGS. 52 through 56. One of the main differences between the locking pin (116) and (116′) resides in that the locking pin component (116′) possess flat surfaces (304) and (308) to spread evenly the stress coming from the handle (20) and stem component (18). The generally rectangular and rounded surface (300) extends outwardly on side developing rounded surface (301) and (302) to promote easy adjustment while reducing pain on user's fingers. One the other side, an elevated abutment ridged (306) departing perpendicularly in both directions from surface (304) and (308). It should be understood that other configurations of the general shape (300), (301), (302) or stress reducing flat surfaces (304), (308) could be used without departing from the scope of the present invention.

The embodiments of the invention in which an exclusive privilege or property is claimed are defined as follows:

1. A walking cane for at least partially supporting the weight of an intended user as the latter is walking, said walking cane comprising:
a handle section for allowing grasping of the cane, a sole section for engaging the ground surface and a stem section extending between said handle section and said sole section;
said handle section projecting substantially forwardly from said stem section, said handle section having a generally elongated configuration defining a handle longitudinal axis, a handle tear end located adjacent said stem section and a longitudinally opposed handle front end;
said stem section having a generally elongated configuration defining a stem longitudinal axis, a stem proximal end located adjacent said handle section and a stem distal end located adjacent said sole section; said stem having a substantially continuous stem outer wall;
said stem section being configured and sized so as to substantially compensate without substantially bending for bending moments created in said stem section during use of said walking cane.

2. A walking cane as recited in claim 1 wherein said stem section includes a bending moment compensating segment located intermediate said stem proximal and distal ends for compensating the bending moments created in said stem section during use.

3. A walking cane as recited in claim 2, wherein said stem section further includes a stem connecting segment located adjacent said stem proximal end for allowing attachment thereto of said handle section.

4. A walking cane as recited in claim 3, wherein the transversal cross-sectional configuration of said stem connecting segment has a substantially oval shape defining a major axis and a minor axis, said major axis being oriented so as to extend substantially between front and rear edges of said stem outer wall.

5. A walking cane as recited in claim 3, wherein said stem section also includes a stem attachment segment located intermediate said stem distal end and said bending moment compensating segment for allowing attachment thereto of said sole section.

6. A walking cane as recited in claim 4, wherein said stem section still further includes a stem spacing segment located intermediate said stem connecting and bending moment compensating segments for spacing the latter.

7. A walking cane as recited in claim 6, wherein the transversal cross-sectional configuration of said stem connecting segment has a substantially oval shape defining a major axis and a minor axis, said major axis being oriented so as to extend substantially between the front and rear edges of said stem outer wall, in a direction leading from said stem connecting segment to said stem spacing segment, the overall circumference of said stem section increasing with the rate of increase ratio of said minor axis being greater than that of said major axis.

8. A walking cane for at least partially supporting the weight of said intended user as the latter is walking, said walking cane comprising:
a handle section for allowing grasping of the cane, a sole section for engaging the ground surface and a stem section extending between said handle section and said sole section; said handle section;
said handle section projecting substantially forwardly from said stem section, said handle section having a generally elongated configuration defining a handle longitudinal axis, a handle rear end located adjacent said stem section and a longitudinally opposed handle front end;
said stem section having a generally elongated configuration defining a stem longitudinal axis, a stem proximal end located adjacent said handle section and a stem distal end located adjacent said sole section; said stem having a substantially continuous stem outer wall, said stem section being configured such that when seen from a side view, said stem section outer wall is wider adjacent said stem distal end then adjacent said stem proximal end.

9. A walking cane as recited in claim 8, wherein said stem section is configured such that when seen from a front and rear view, said stem section outer wall is wider adjacent said stem distal end then adjacent said stem proximal end.

10. A walking cane as recited in claim 8, wherein said stem outer wall defines a stem front edge and a stem rear edge, said stem outer wall being configured such that said stem longitudinal axis is substantially centered relative to said stem front and rear edges adjacent said stem proximal end and such that said stem longitudinal axis is offset towards said stem rear edge and away from said stem front edge adjacent said stem distal end.

11. A walking cane as recited in claim 8, wherein said stem outer wall defines a stem front edge and a stem rear edge; said stem front edge flaring frontwardly substantially adjacent said stem distal end.

12. A walking cane as recited in claim 8, wherein said stem outer wall defines a stem front edge and a stem rear edge; said stem rear edge flaring rearwardly substantially adjacent said stem distal end.

13. A walking cane as recited in claim 8, wherein said stem outer wall defines a stem front edge and a stem rear edge; said stem front edge flaring frontwardly substantially adjacent said stem distal end; said stem rear edge flaring rearwardly substantially adjacent said stem distal end.

14. A walking cane as recited in claim 13, wherein said stem front edge flares frontwardly over a front flaring distance and said stem rear edge flares rearwardly over a rear flaring distance, said front flaring distance being greater then said rear flaring distance adjacent said stem distal end so that said stem longitudinal axis is offset towards said stem rear edge adjacent said stem distal end.

15. A walking cane as recited in claim 8, wherein said stem outer wall defines a stem distal edge, said stem distal edge having a substantially convex configuration when seen from a side view.

16. A walking cane as recited in claim 8, wherein said stem outer wall defines a stem distal edge, said stem distal edge having a substantially convex configuration when seen from a side view.

17. A walking cane as recited in claim 8, wherein said stem outer wall defines a stem distal edge, said stem distal edge having a substantially concave configuration when seen from a front view.

18. A walking cane as recited in claim 8, wherein said stem outer wall defines a stem distal edge, said stem distal edge having a substantially convex configuration when seen from a side view and a substantially concave configuration when seen from a front view.

19. A walking cane for at least partially supporting the weight of an intended user as the latter is walking, said intended user transmitting to said cane an applied force during use thereof, said applied force having a substantially vertical vector component, said walking cane comprising:
a handle section for allowing grasping of the cane, a sole section for engaging the ground surface and a stem section extending between said handle section and said sole section; said handle section, said sole section and said stem section together defining a cane center of gravity;
said stem section having a generally elongated configuration defining a stem longitudinal axis, a stem proximal end located adjacent said handle section and a stem distal end located adjacent said sole section;
said handle section having a generally elongated configuration defining a handle longitudinal axis, a handle rear end located adjacent said stem section and a longitudinally opposed handle front end;
said handle section, said stem section and said sole section being configured and sized so that said stem longitudinal axis is substantially in register with said cane center of gravity when said cane is in a substantially vertical orientation and so that said vector component is in a substantially collinear relationship with said stem longitudinal axis.

20. A walking cane as recited in claim 19, wherein said stem section is substantially hollow.

21. A walking cane as recited in claim 19, wherein the transversal cross-sectional configuration of said stem adjacent said stem proximal end has a substantially oval shape defining a major axis and a minor axis, said major axis being oriented so as to extend substantially between front and rear edges of said stem outer wall; said stem longitudinal axis being substantially in register with the intersection between said major and minor axes.

22. A walking cane as recited in claim 19, wherein said sole section has a generally elongated configuration defining a sole longitudinal axis, a sole rear end, a longitudinally opposed sole front end and a pair of sole side ends extending therebetween.
